(19) United States
(12) Patent Application Publication
(10) Pub. No.: US 2024/0171288 A1
(43) Pub. Date: May 23, 2024

(54) LIGHT-RECEIVING DEVICE, RECEPTION DEVICE, AND COMMUNICATION DEVICE

(71) Applicant: NEC Corporation, Minato-ku, Tokyo (JP)

(72) Inventors: Koya TAKATA, Tokyo (JP); Hisashi MIZUMOTO, Tokyo (JP); Fujio OKUMURA, Kanagawa (JP)

(73) Assignee: NEC Corporation, Minato-ku, Tokyo (JP)

(21) Appl. No.: 18/282,897

(22) PCT Filed: Feb. 10, 2022
(86) PCT No.: PCT/JP2022/005238

§ 371 Date: Sep. 19, 2023

(30) Foreign Application Priority Data
Mar. 22, 2021 (JP) 2021-047564

(51) Int. Cl. H04B 10/67; G02B 3/14; G02F 1/13; H04B 10/11

(52) U.S. Cl. CPC H04B 10/67; G02B 3/14; G02F 1/13; H04B 10/11

(57) ABSTRACT

A light-receiving device includes a condenser lens configured to condense a spatial optical signal, a variable lens in which a lens region is formed at an arbitrary position, the variable lens focusing an optical signal derived from the spatial optical signal condensed by the condenser lens in the lens region, a control unit configured to form the lens region at a desired position of the variable lens and control an emission direction of the optical signal emitted from the variable lens, and a light-receiving element that is disposed with a light-receiving part facing the variable lens and receives the optical signal focused by the variable lens.

### TECHNICAL FIELD

The present disclosure relates to a light-receiving device or the like that receives a spatial optical signal.

### BACKGROUND ART

In optical space communication, an optical signal (hereinafter, also referred to as a spatial optical signal) propagating in a space is transmitted and received without using a medium such as an optical fiber. In order to receive a spatial optical signal that spreads and propagates in a space, a condenser lens as large as possible is required. Furthermore, in optical space communication, a photodiode having a small capacitance is required to perform high-speed communication. Since such a photodiode has a very small light-receiving surface, it is difficult to condense spatial optical signals arriving from various directions toward the light-receiving surface with a large condenser lens.

PTL 1 discloses a light-receiving device that filters condensed light. The device of PTL 1 includes a first condenser lens, a collimator lens, a band-pass filter, and a light-receiving element. The collimator lens has a focal length shorter than the focal length of the first condenser lens, and converts light condensed by the condenser lens into parallel light. The parallel light from the collimator lens is incident perpendicularly to the filter surface of the band-pass filter. The light transmitted through the band-pass filter that transmits only the wavelength of the incident light is received by the light-receiving element. PTL 1 discloses a configuration in which a second condenser lens that condenses light having passed through a band-pass filter is arranged or an aperture is arranged at a focal position of the condenser lens, so that light condensed by the condenser lens is easily guided to a light-receiving element. In addition, PTL 1 discloses a mechanism that moves a condenser lens or an aperture in three axial directions according to an incident angle of light to adjust the condenser lens or the aperture to an optimum position.

### CITATION LIST

### Patent Literature

PTL 1: JP 2019-186595 A

### SUMMARY OF INVENTION

### Technical Problem

According to the method of PTL 1, the spatial light can be guided to the light-receiving element by condensing the light having passed through the band-pass filter on the second condenser lens or adjusting the condenser lens or the aperture to an optimum position according to the incident angle of the light. However, in the method of PTL 1, the intensity of the light guided to the light-receiving element changes according to the incident angle of the spatial light. Therefore, in the method of PTL 1, the spatial light cannot be efficiently received depending on the arrival direction of the spatial light.

An object of the present disclosure is to provide a light-receiving device and the like capable of efficiently receiving a spatial optical signal arriving from an arbitrary direction.

### Solution to Problem

A light-receiving device according to one aspect of the present disclosure includes a condenser lens configured to condense a spatial optical signal, a variable lens in which a lens region is formed at an arbitrary position, the variable lens focusing an optical signal derived from the spatial optical signal condensed by the condenser lens in the lens region, a control unit configured to form the lens region at a desired position of the variable lens and control an emission direction of the optical signal emitted from the variable lens, and a light-receiving element that is disposed with a light-receiving part facing the variable lens and receives the optical signal focused by the variable lens.

### Advantageous Effects of Invention

According to the present disclosure, it is possible to provide a light-receiving device and the like capable of efficiently receiving a spatial optical signal arriving from an arbitrary direction.

### BRIEF DESCRIPTION OF DRAWINGS

FIG. 1 is a conceptual diagram illustrating an example of a configuration of a light-receiving device of a first example embodiment.

FIG. 2 is a conceptual diagram illustrating an example of a trajectory of light in the light-receiving device of the first example embodiment.

FIG. 3 is a conceptual diagram illustrating another example of a trajectory of light in the light-receiving device of the first example embodiment.

FIG. 4 is a conceptual diagram illustrating an example of control of a liquid-crystal lens in the light-receiving device of the first example embodiment.

FIG. 5 is a conceptual diagram illustrating an example of a configuration of a light-receiving device of a second example embodiment.

FIG. 6 is a conceptual diagram illustrating an example of a configuration of an imaging unit of the light-receiving device according to the second example embodiment.

FIG. 7 is a conceptual diagram illustrating an example of a configuration of a light-receiving device of a third example embodiment.

FIG. 8 is a conceptual diagram illustrating an example of a trajectory of light in the light-receiving device of the third example embodiment.

FIG. 9 is a conceptual diagram illustrating an example of a configuration of a light-receiving device of a fourth example embodiment.

FIG. 10 is a conceptual diagram illustrating an example of a trajectory of light in the light-receiving device of the fourth example embodiment.

FIG. 11 is a conceptual diagram illustrating an example of a virtual lens image displayed on a surface of a liquid-crystal lens of the light-receiving device of a fourth example embodiment.

FIG. 12 is a conceptual diagram illustrating an example of a trajectory of light in a modification of the light-receiving device of the fourth example embodiment.

FIG. 13 is a conceptual diagram illustrating an example of a configuration of a light-receiving device of a fifth example embodiment.

FIG. 14 is a conceptual diagram illustrating an example of a trajectory of light in the light-receiving device of the fifth example embodiment.

FIG. 15 is a block diagram illustrating an example of a configuration of a decoder included in the light-receiving device of the fifth example embodiment.

FIG. 16 is a conceptual diagram illustrating an example of a configuration of a light-receiving device of a sixth example embodiment.

FIG. 17 is a conceptual diagram illustrating an example of a trajectory of light in the light-receiving device of the sixth example embodiment.

FIG. 18 is a conceptual diagram illustrating an example of a trajectory of light in a modification of the light-receiving device of the sixth example embodiment.

FIG. 19 is a block diagram illustrating an example of a configuration of a decoder included in the light-receiving device of the sixth example embodiment.

FIG. 20 is a conceptual diagram illustrating an example of a configuration of a communication device according to a seventh example embodiment.

FIG. 21 is a conceptual diagram illustrating an example of a configuration of a light-transmitting unit included in the communication device according to the seventh example embodiment.

FIG. 22 is a conceptual diagram for describing an application example of the communication device of the seventh example embodiment.

FIG. 23 is a conceptual diagram illustrating an example of a configuration of a light-receiving device of an eighth example embodiment.

FIG. 24 is a block diagram illustrating an example of a hardware configuration that executes control and processing according to each example embodiment.

### EXAMPLE EMBODIMENT

Hereinafter, example embodiments of the present invention will be described with reference to the drawings. However, the example embodiments described below have technically preferable limitations for carrying out the present invention, but the scope of the invention is not limited to the following. In all the drawings used in the following description of the example embodiment, the same reference numerals are given to the same parts unless otherwise specified. In all the drawings used for describing the following example embodiments, reference numerals of similar configurations may be omitted. In the following example embodiments, repeated description of similar configurations and operations may be omitted.

In all the drawings used for description of the following example embodiments, the directions of the arrows in the drawings are merely examples, and do not limit the directions of light and signals. In addition, a line indicating a trajectory of light in the drawings is conceptual, and does not accurately indicate an actual traveling direction or state of light. For example, in the following drawings, a change in a traveling direction or a state of light due to refraction, reflection, diffusion, or the like at an interface between air and a substance may be omitted, or a light flux may be expressed by one line.

### First Example Embodiment

First, a light-receiving device according to a first example embodiment will be described with reference to the drawings. The light-receiving device of the present example embodiment is used for optical space communication in which optical signals (hereinafter, also referred to as spatial optical signals) propagating in a space are transmitted and received without using a medium such as an optical fiber. The light-receiving device of the present example embodiment may be used for applications other than optical space communication as long as the light-receiving device receives light propagating in a space. Hereinafter, unless otherwise specified, the spatial optical signal is regarded as parallel light because the spatial optical signal arrives from a sufficiently distant position.

### Configuration

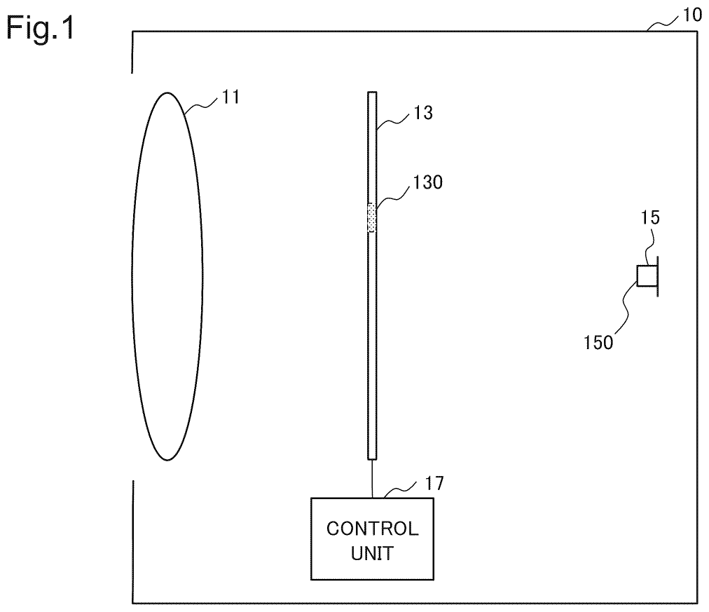

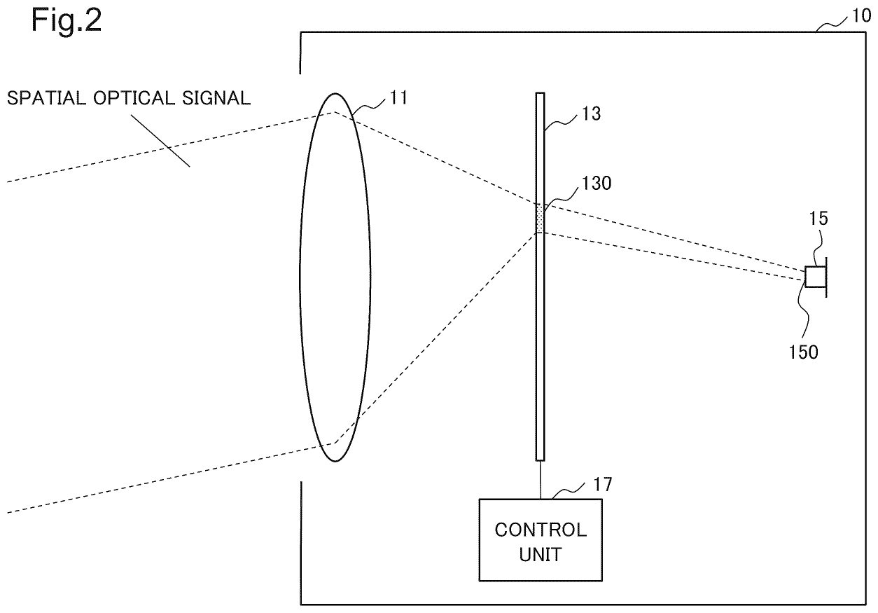

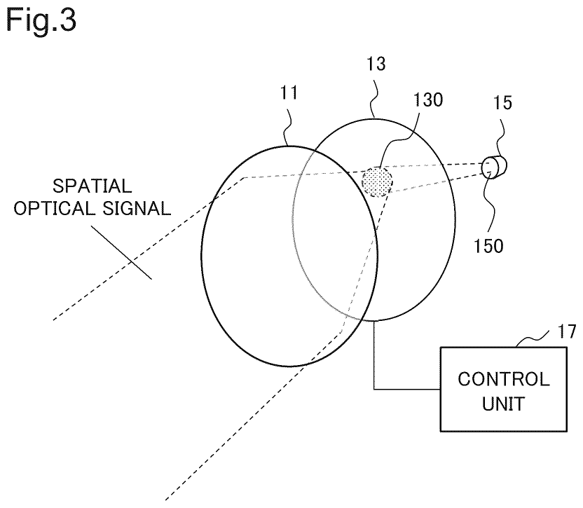

FIG. 1 is a conceptual diagram illustrating an example of a configuration of a light-receiving device 10 of the present example embodiment. The light-receiving device 10 includes a condenser lens 11, a liquid-crystal lens 13, a light-receiving element 15, and a control unit 17. FIGS. 2 and 3 are conceptual diagrams for describing an example of a trajectory of light received by the light-receiving device 10. FIGS. 1 and 2 are diagrams of the internal configuration of the light-receiving device 10 as viewed from the lateral direction. FIG. 3 is a perspective view of the internal configuration of the light-receiving device 10 as viewed obliquely in front of the incident surface side.

The condenser lens 11 is an optical element that condenses a spatial optical signal arriving from the outside. The light (also referred to as an optical signal) derived from the spatial optical signal condensed by the condenser lens 11 is condensed toward the incident surface of the liquid-crystal lens 13. For example, the condenser lens 11 can be made of a material such as glass or plastic. For example, the condenser lens 11 is made of a material such as quartz. When the spatial optical signal is light in an infrared region (hereinafter, also referred to as infrared rays), a material that transmits infrared rays is preferably used for the condenser lens 11. For example, the condenser lens 11 may be made of silicon, germanium, or a chalcogenide material. The material of the condenser lens 11 is not limited as long as the light in the wavelength region of the spatial optical signal can be refracted and transmitted.

The liquid-crystal lens 13 (also referred to as a variable lens) is disposed at a subsequent stage of the condenser lens 11. The liquid-crystal lens 13 is disposed such that an incident surface thereof faces an emission surface of the condenser lens 11. In order for the light-receiving element 15 to efficiently receive the optical signal, the liquid-crystal lens 13 is preferably disposed such that the incident surface of the liquid-crystal lens 13 is located in front of the focal position of the condenser lens 11.

The liquid-crystal lens 13 is a lens using liquid crystal. For example, the liquid-crystal lens 13 has a structure in which a liquid-crystal lens body in which liquid crystal is sealed between two layers of alignment films is sandwiched between two layers of transparent conductive films. In the liquid-crystal lens 13, the refractive index changes according to the voltage applied between the two layers of transparent conductive films. The range of the focal length of the liquid-crystal lens 13 is set according to the refractive index of the material constituting the liquid-crystal lens 13. The lens region 130 is formed at an arbitrary position of the liquid-crystal lens 13 under the control of the control unit 17. For example, the lens region can be formed at an arbitrary position of the liquid-crystal lens 13 by adjusting the portion to which the voltage is applied. A focal length of the lens region 130 formed in the liquid-crystal lens 13 can be changed according to an applied voltage. A plurality of lens regions 130 can be formed in the liquid-crystal lens 13. The focusing direction and the focal length of the plurality of lens regions 130 formed in the liquid-crystal lens 13 can be individually set by adjusting the applied voltage.

Under the control of the control unit 17, the liquid-crystal lens 13 diffracts the optical signal incident on the lens region 130 from the incident surface, and emits the optical signal from the emission surface toward the region where the light-receiving element 15 is disposed. That is, the emission direction of the optical signal incident on the liquid-crystal lens 13 is controlled according to the control by the control unit 17, and the optical signal is focused toward the light-receiving part 150 of the light-receiving element 15. FIGS. 2 and 3 illustrate an example in which the spatial optical signal incident on the condenser lens 11 is condensed by the condenser lens 11 and is incident on the lens region 130 of the liquid-crystal lens 13. The liquid-crystal lens 13 emits the optical signal incident on the lens region 130 toward the region where the light-receiving element 15 is disposed. As a result, the optical signal derived from the spatial optical signal is received by the light-receiving part 150 of the light-receiving element 15.

The light-receiving element 15 is disposed at a subsequent stage of the liquid-crystal lens 13. The light-receiving element 15 includes a light-receiving part 150 that receives the optical signal emitted from the liquid-crystal lens 13. The light-receiving element 15 is disposed such that the light-receiving part 150 faces the emission surface of the liquid-crystal lens 13. In the light-receiving element 15, the light-receiving part 150 receives the optical signal emitted from the liquid-crystal lens 13.

The light-receiving element 15 receives light in a wavelength region of an optical signal to be received. For example, the light-receiving element 15 receives an optical signal in the visible region. For example, the light-receiving element 15 receives an optical signal in an infrared region. The light-receiving element 15 receives an optical signal having a wavelength in a 1.5 μm (micrometer) band, for example. The wavelength band of the optical signal received by the light-receiving element 15 is not limited to the 1.5 μm band. The wavelength band of the optical signal received by the light-receiving element 15 can be arbitrarily set according to the wavelength of the spatial optical signal transmitted from a light-transmitting device (not illustrated). The wavelength band of the optical signal received by the light-receiving element 15 may be set to, for example, a 0.8 μm band, a 1.55 μm band, or a 2.2 μm band. Furthermore, the wavelength band of the optical signal received by the light-receiving element 15 may be, for example, a 0.8 to 1 μm band. When the wavelength band of the optical signal is short, absorption by moisture in the atmosphere is small, which is advantageous for optical spatial communication during rainfall. Furthermore, the light-receiving element 15 may receive an optical signal in the visible region. In addition, if the light-receiving element 15 is saturated with intense sunlight, the light-receiving element cannot read the optical signal derived from the spatial optical signal. Therefore, a color filter that selectively passes the light in the wavelength band of the spatial optical signal may be installed in the preceding stage of the light-receiving element 15.

The light-receiving element 15 converts the received optical signal into an electric signal. The light-receiving element 15 outputs the converted electric signal to a decoder (not illustrated). For example, the light-receiving element 15 can be realized by an element such as a photodiode or a phototransistor. For example, the light-receiving element 15 is realized by an avalanche photodiode. The light-receiving element 15 realized by an avalanche photodiode can support high-speed communication. The light-receiving element 15 may be realized by an element other than a photodiode, a phototransistor, or an avalanche photodiode as long as an optical signal can be converted into an electric signal.

In order to improve the communication speed, the light-receiving part 150 of the light-receiving element 15 is preferably as small as possible. For example, the light-receiving part 150 of the light-receiving element 15 has a light-receiving region having a diameter of about 0.1 to 0.3 mm (millimeter). The optical signal condensed by the condenser lens 11 is condensed within a certain range depending on the arrival direction of the spatial optical signal, but cannot be condensed in a predetermined region where the light-receiving part 150 of the light-receiving element 15 is disposed. In the present example embodiment, by using the liquid-crystal lens 13 that selectively guides the optical signal condensed by the condenser lens 11 to a predetermined region, the optical signal condensed by the condenser lens 11 is guided to the region where the light-receiving part 150 of the light-receiving element 15 is located. Therefore, the light-receiving device 10 can efficiently guide the spatial optical signal arriving at the incident surface of the condenser lens 11 from an arbitrary direction to the light-receiving part 150 of the light-receiving element 15.

The control unit 17 controls the liquid-crystal lens 13 such that the optical signal incident on the incident surface of the liquid-crystal lens 13 is emitted toward the position (predetermined region) where the light-receiving part 150 of light-receiving element 15 is disposed. For example, the control unit 17 is realized by a microcomputer including a processor and a memory. For example, the control unit 17 forms the lens region 130 at a desired position of the liquid-crystal lens 13 by controlling a voltage applied to the liquid-crystal lens 13. The control unit 17 changes the refractive index of the lens region 130 by adjusting the voltage applied to the liquid-crystal lens 13. When the refractive index of the lens region 130 is changed, the spatial optical signal incident on the liquid-crystal lens 13 is appropriately diffracted according to the refractive index of the lens region 130. That is, the spatial optical signal incident on the liquid-crystal lens 13 is diffracted according to the optical characteristics of the lens region 130. The method for driving the liquid-crystal lens 13 by the control unit 17 is not limited to the method described herein.

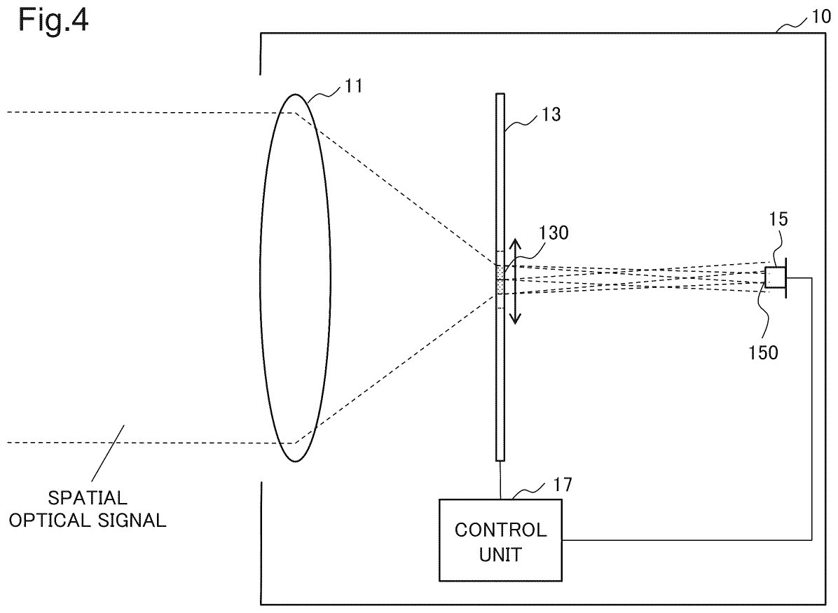

FIG. 4 is a conceptual diagram for describing a control example of the liquid-crystal lens 13 by the control unit 17. FIG. 4 is a view of the internal configuration of the light-receiving device 10 as viewed from the lateral direction. In the control example of FIG. 4, the control unit 17 is connected to the light-receiving element 15. The control unit 17 receives the optical signal received by the light-receiving element 15 and measures the intensity of the optical signal.

The control unit 17 performs light beam direction detection for detecting the arrival direction of the spatial optical signal of the optical signal according to the position where the optical signal condensed by the condenser lens 11 is incident on the liquid-crystal lens 13. For example, the control unit 17 moves the lens region 130 within a predetermined range and scans the emission direction of the optical signal. For example, the control unit 17 moves the lens region 130 within a predetermined range along the vertical direction or the horizontal direction, and scans the emission direction of the optical signal. The control unit 17 performs adjustment such that a lens region is formed in a region where the intensity (also referred to as received light intensity) of the optical signal received by the light-receiving element 15 is maximized.

The control unit 17 performs light beam direction detection at a predetermined timing. The timing of the light beam direction detection by the control unit 17 can be arbitrarily set. For example, the control unit 17 is set to perform the light beam direction detection at the timing when the light-receiving element 15 receives the optical signal derived from the spatial optical signal. For example, the control unit 17 performs the light beam direction detection at a stage where the light reception of the optical signal derived from the spatial optical signal arriving from the same arrival direction is started. For example, the control unit 17 performs the light beam direction detection at timing when the light-receiving position of the optical signal on the incident surface of the liquid-crystal lens 13 changes. For example, the control unit 17 performs the light beam direction detection at a timing when the received light intensity of the optical signal changes to a threshold or more. When the arrival direction of the spatial optical signal is fixed, the light beam direction detection may not be performed.

As described above, the light-receiving device according to the present example embodiment includes the condenser lens, the liquid-crystal lens, the control unit, and the light-receiving element. The condenser lens receives a spatial optical signal. In the liquid-crystal lens (variable lens), a lens region is formed at an arbitrary position. The liquid-crystal lens focuses an optical signal derived from a spatial optical signal condensed by the condenser lens in a lens region. The control unit forms a lens region at a desired position of the liquid-crystal lens. The control unit controls an emission direction of the optical signal emitted from the liquid-crystal lens. The light-receiving element is disposed with the light-receiving part facing the liquid-crystal lens. The light-receiving element receives the optical signal focused by the liquid-crystal lens.

The light-receiving device according to the present example embodiment diffracts the optical signal condensed by the condenser lens in the lens region formed in the variable lens, and guides the optical signal to the light-receiving part of the light-receiving element. Therefore, according to the present example embodiment, spatial light arriving from an arbitrary direction can be efficiently received.

In one aspect of the present example embodiment, the liquid-crystal lens (variable lens) is a transmissive liquid-crystal lens. The control unit adjusts a voltage applied to the liquid-crystal lens to form a lens region at a desired position of the liquid-crystal lens. According to the present aspect, by forming the lens region at a desired position of the liquid-crystal lens, spatial light arriving from an arbitrary direction can be efficiently received.

In one aspect of the present example embodiment, the control unit moves the position of the lens region to scan the emission direction of the optical signal emitted from the liquid-crystal lens (variable lens). The control unit detects the arrival direction of the spatial optical signal based on the received light intensity of the optical signal by the light-receiving element. The control unit causes the variable lens to form a lens region according to the detected arrival direction of the spatial optical signal. According to the present aspect, since the direction in which the liquid-crystal lens focuses the optical signal can be optimized according to the arrival direction of the spatial optical signal, the light-receiving efficiency of the optical signal by the light-receiving element can be improved.

### Second Example Embodiment

Next, a light-receiving device of a second example embodiment will be described with reference to the drawings. The light-receiving device of the present example embodiment includes an imaging unit (camera) for detecting an arrival direction of a spatial optical signal. The imaging unit may be used for purposes other than detecting the arrival direction of the spatial optical signal.

### Configuration

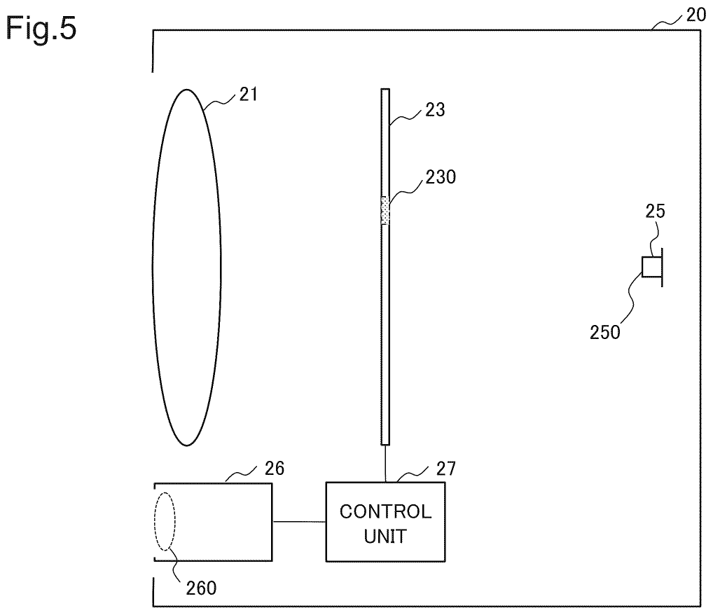

FIG. 5 is a conceptual diagram illustrating an example of a configuration of the light-receiving device 20 of the present example embodiment. The light-receiving device 20 includes a condenser lens 21, a liquid-crystal lens 23, a light-receiving element 25, an imaging unit 26, and a control unit 27. FIG. 5 is a view of the internal configuration of the light-receiving device 20 as viewed from the lateral direction.

The condenser lens 21 is an optical element that condenses a spatial optical signal arriving from the outside. The optical signal condensed by the condenser lens 21 is condensed toward the incident surface of the liquid-crystal lens 23. The condenser lens 21 has the same configuration as the condenser lens 11 of the first example embodiment.

The liquid-crystal lens 23 (also referred to as a variable lens) is disposed at a subsequent stage of the condenser lens 21. The liquid-crystal lens 23 is disposed such that an incident surface thereof faces an emission surface of the condenser lens 21. In the liquid-crystal lens 23, the lens region 230 is formed under the control of the control unit 27. The optical signal incident from the incident surface of the liquid-crystal lens 23 is diffracted by the lens region 230 formed under the control of the control unit 27, and is emitted toward the light-receiving part 250 of the light-receiving element 25. The liquid-crystal lens 23 has the same configuration as the liquid-crystal lens 13 of the first example embodiment.

The light-receiving element 25 is disposed at a subsequent stage of the liquid-crystal lens 23. The light-receiving element 25 includes a light-receiving part 250 that receives the optical signal focused by the liquid-crystal lens 23. The light-receiving element 25 is disposed such that the light-receiving part 250 faces the emission surface of the liquid-crystal lens 23. The light-receiving element 25 is disposed such that the light-receiving part 250 is located in a predetermined region. The optical signal emitted from the liquid-crystal lens 23 is received by the light-receiving part 250 of the light-receiving element 25 located in the predetermined region. The light-receiving element 25 converts the received optical signal into an electric signal. The light-receiving element 25 outputs the converted electric signal to a decoder (not illustrated). The light-receiving element 25 has the same configuration as the light-receiving element 15 of the first example embodiment.

The imaging unit 26 is arranged such that the imaging direction is directed to the arrival direction of the spatial optical signal. The imaging unit 26 captures an image for detecting a spatial optical signal arriving from the outside. For example, the imaging unit 26 has a function of a digital camera. The incident surface of the lens of the imaging unit 26 is arranged in the same direction as the incident surface of the condenser lens 21. The imaging unit 26 images the arrival direction of the spatial optical signal. The imaging unit 26 outputs the captured image to the control unit 27.

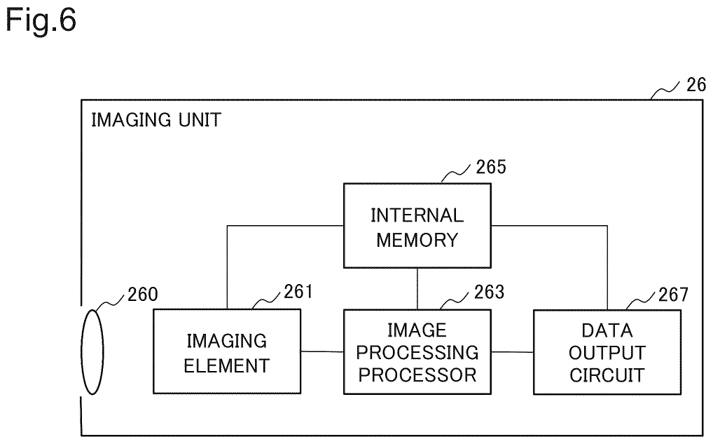

FIG. 6 is a conceptual diagram illustrating an example of a configuration of the imaging unit 26. The imaging unit 26 includes a lens 260, an imaging element 261, an image processing processor 263, an internal memory 265, and a data output circuit 267.

The lens 260 is an optical element for imaging the arrival direction of the spatial optical signal. The lens 260 can be made of a material such as glass or plastic. For example, the lens 260 is made of a material such as quartz. When the spatial optical signal is light in an infrared region (hereinafter, also referred to as infrared rays), a material that transmits infrared rays is preferably used for the lens 260. For example, the lens 260 may be made of silicon, germanium, or a chalcogenide material. The material of the lens 260 is not limited as long as the light in the wavelength region of the spatial optical signal can be refracted and transmitted.

The imaging element 261 is an element for capturing an arrival direction of the spatial optical signal and detecting the arrival direction. The imaging element 261 is a photoelectric conversion element in which a semiconductor component is integrated. The imaging element 261 can be realized by, for example, a solid-state imaging element such as a charge-coupled device (CCD) or a complementary metal-oxide-semiconductor (CMOS). The imaging element 261 has a number of pixels capable of detecting the arrival direction of the spatial optical signal. Usually, the imaging element 261 images light in a visible region. The imaging element 261 may include an element capable of imaging infrared rays, ultraviolet rays, or the like.

The image processing processor 263 is an integrated circuit that executes image processing such as dark current correction, interpolation calculation, color space conversion, gamma correction, aberration correction, noise reduction, and image compression on the imaging data imaged by the imaging element 261 and converts the imaging data into image data. When the image information is not processed, the image processing processor 263 may be omitted.

The internal memory 265 is a storage element that temporarily stores image information that the image processing processor 263 cannot process or processed image information. Furthermore, the internal memory 265 may be configured to temporarily store image information captured by the imaging element 261. The internal memory 265 may be configured by a general memory.

The data output circuit 267 outputs the image data processed by the image processing processor 263 to the control unit 27. The image data output to the control unit 27 is used for detection of the arrival direction of the spatial optical signal (light beam direction detection). The light-receiving position of the spatial optical signal in the pixel of the imaging element 261 may be output from the data output circuit 267 to the control unit 27.

The control unit 27 controls the liquid-crystal lens 23 such that the optical signal incident on the incident surface of the liquid-crystal lens 23 is emitted toward the position (predetermined region) where the light-receiving part 250 of the light-receiving element 25 is disposed. The control unit 27 performs light beam direction detection for detecting the arrival direction of the spatial optical signal based on the image captured by the imaging unit 26. For example, the control unit 27 detects the arrival direction of the spatial optical signal based on the position of the spatial optical signal in the image captured by the imaging unit 26. For example, in a case where the light-receiving position of the spatial optical signal in the pixel of the imaging element 261 can be received, the light beam direction detection may be performed based on the light-receiving position. The control unit 27 causes the liquid-crystal lens 23 to form the lens region 230 according to the arrival direction of the spatial optical signal.

For example, the control unit 27 is set to perform the light beam direction detection at a timing when the optical signal derived from the spatial optical signal is detected from the image captured by the imaging unit 26. For example, the control unit 27 performs the light beam direction detection at a stage where the light reception of the optical signal derived from the spatial optical signal arriving from the same arrival direction is started. For example, the control unit 27 performs the light beam direction detection at timing when the light-receiving position of the optical signal on the incident surface of the liquid-crystal lens 23 changes. For example, the control unit 27 performs the light beam direction detection at a predetermined timing set in advance. The timing of the light beam direction detection by the control unit 27 can be arbitrarily set. In addition, the light beam direction detection may be performed by combining a method of scanning the emission direction of the optical signal emitted from the emission surface of the liquid-crystal lens 23 as in the first example embodiment and a method using the imaging unit 26 of the present example embodiment.

As described above, the light-receiving device of the present example embodiment includes the condenser lens, the imaging unit, the liquid-crystal lens, the control unit, and the light-receiving element. The condenser lens receives a spatial optical signal. The imaging unit images an arrival direction of the spatial optical signal. In the liquid-crystal lens (variable lens), a lens region is formed at an arbitrary position. The liquid-crystal lens focuses an optical signal derived from a spatial optical signal condensed by the condenser lens in a lens region. The control unit detects an arrival direction of the spatial optical signal based on the image captured by the imaging unit. The control unit causes the variable lens to form a lens region according to the detected arrival direction of the spatial optical signal. The control unit controls an emission direction of the optical signal emitted from the liquid-crystal lens. The light-receiving element is disposed with the light-receiving part facing the liquid-crystal lens. The light-receiving element receives the optical signal focused by the liquid-crystal lens.

The light-receiving device of the present example embodiment causes the liquid-crystal lens to form the lens region according to the arrival direction of the spatial optical signal detected based on the image captured by the imaging unit. Therefore, according to the present example embodiment, the direction in which the liquid-crystal lens focuses the optical signal can be optimized according to the arrival direction of the spatial optical signal, and the light-receiving efficiency of the optical signal by the light-receiving element can be improved.

### Third Example Embodiment

Next, a light-receiving device according to a third example embodiment will be described with reference to the drawings. The light-receiving device of the present example embodiment is applied to a situation in which the direction in which the spatial optical signal arrives is limited to some extent. The light-receiving device of the present example embodiment includes an elongated liquid-crystal lens set according to an arrival direction of a spatial optical signal. In the present example embodiment, the arrival direction of the spatial optical signal is limited to the horizontal direction, and the shape of the liquid-crystal lens is elongated in the horizontal direction according to the arrival direction. The light-receiving device of the present example embodiment may include the imaging unit of the second example embodiment.

### Configuration

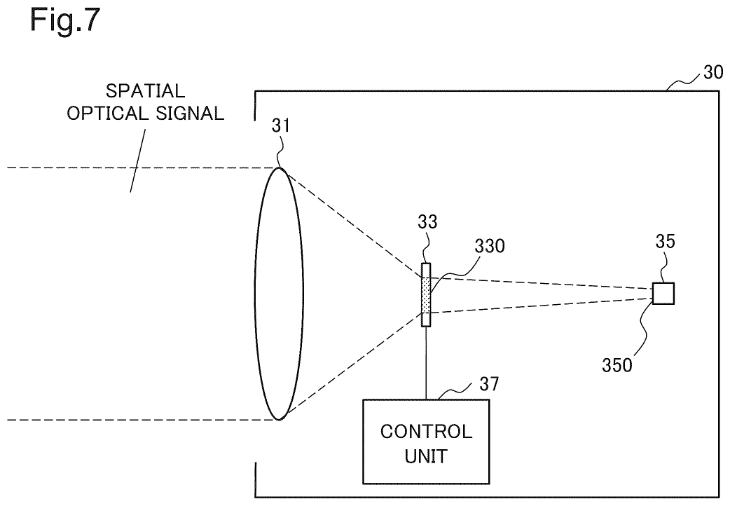

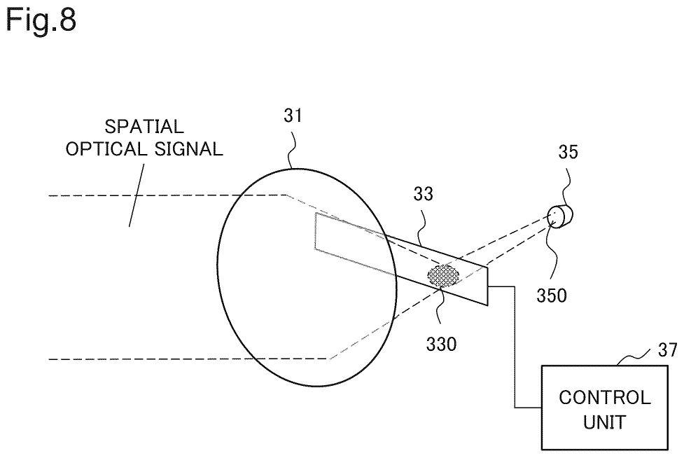

FIG. 7 is a conceptual diagram illustrating an example of a configuration of the light-receiving device 30 of the present example embodiment. The light-receiving device 30 includes a condenser lens 31, a liquid-crystal lens 33, a light-receiving element 35, and a control unit 37. FIG. 7 is a view of the internal configuration of the light-receiving device 30 as viewed from the lateral direction. FIG. 8 is a conceptual diagram for describing an example of a trajectory of light received by the light-receiving device 30. FIG. 8 is a perspective view of the internal configuration of the light-receiving device 30 as viewed obliquely in front of the incident surface side.

The condenser lens 31 is an optical element that condenses a spatial optical signal arriving from the outside. The optical signal condensed by the condenser lens 31 is condensed toward the incident surface of the liquid-crystal lens 33. The condenser lens 31 has the same configuration as the condenser lens 11 of the first example embodiment. The condenser lens 31 may be configured to condense light according to the shape of the liquid-crystal lens 33.

The liquid-crystal lens 33 (also referred to as a variable lens) is disposed at a subsequent stage of the condenser lens 31. The liquid-crystal lens 33 is disposed such that an incident surface thereof faces an emission surface of the condenser lens 31. The liquid-crystal lens 33 is set in a shape corresponding to the arrival direction of the spatial optical signal. For example, when the spatial optical signal arrives from the horizontal direction, the liquid-crystal lens 33 is set to a shape having a long axis in the horizontal direction and a short axis in the vertical direction. For example, when the spatial optical signal arrives from a direction (hereinafter, referred to as a vertical direction) perpendicular to the horizontal plane, the liquid-crystal lens 33 is set to a shape having a major axis in the vertical direction and a minor axis in the horizontal direction. The shape of the liquid-crystal lens 33 may be set according to the arrival direction of the spatial optical signal.

In the liquid-crystal lens 33, the lens region 330 is formed under the control of the control unit 37. The optical signal incident from the incident surface of the liquid-crystal lens 33 is diffracted by lens region 330 formed under the control of the control unit 37, and is emitted toward the light-receiving part 350 of the light-receiving element 35. The liquid-crystal lens 33 has the same configuration as the liquid-crystal lens 13 of the first example embodiment except for its shape.

The light-receiving element 35 is disposed at a subsequent stage of the liquid-crystal lens 33. The light-receiving element 35 includes a light-receiving part 350 that receives the optical signal focused by the liquid-crystal lens 33. The light-receiving element 35 is disposed such that the light-receiving part 350 faces the emission surface of the liquid-crystal lens 33. The light-receiving element 35 is disposed such that the light-receiving part 350 is located in a predetermined region. The optical signal emitted from the liquid-crystal lens 33 is received by the light-receiving part 350 of the light-receiving element 35 located in the predetermined region. The light-receiving element 35 converts the received optical signal into an electric signal. The light-receiving element 35 outputs the converted electric signal to a decoder (not illustrated). The light-receiving element 35 has the same configuration as the light-receiving element 15 of the first example embodiment.

The control unit 37 controls the liquid-crystal lens 33 such that the optical signal incident on the incident surface of the liquid-crystal lens 33 is emitted toward the position (predetermined region) where the light-receiving part 350 of the light-receiving element 35 is disposed. The control unit 37 causes the liquid-crystal lens 33 to form the lens region 330 according to the arrival direction of the spatial optical signal. The control unit 37 has the same configuration as the control unit 17 of the first example embodiment.

As described above, the light-receiving device according to the present example embodiment includes the condenser lens, the liquid-crystal lens, the control unit, and the light-receiving element. The condenser lens receives a spatial optical signal. The liquid-crystal lens (variable lens) has a shape corresponding to the arrival direction of the spatial optical signal. In the liquid-crystal lens, a lens region is formed at an arbitrary position. The liquid-crystal lens focuses an optical signal derived from a spatial optical signal condensed by the condenser lens in a lens region. The control unit forms a lens region at a desired position of the liquid-crystal lens. The control unit controls an emission direction of the optical signal emitted from the liquid-crystal lens. The light-receiving element is disposed with the light-receiving part facing the liquid-crystal lens. The light-receiving element receives the optical signal focused by the liquid-crystal lens.

According to the light-receiving device of the present example embodiment, by using the liquid-crystal lens having a shape corresponding to the arrival direction of the spatial optical signal, it is possible to efficiently receive the spatial optical signal with a limited arrival direction. For example, in a case where the arrival direction of the spatial optical signal from the communication target is limited to the horizontal direction, the vertical direction, or the like, it is not necessary to receive light arriving from a direction different from these directions. In the present example embodiment, the arrival direction of the spatial optical signal is limited to the horizontal direction, and the shape of the liquid-crystal lens is elongated along the horizontal direction according to the arrival direction. When the arrival direction of the spatial optical signal is limited to the vertical direction, the shape of the liquid-crystal lens may be elongated along the vertical direction according to the arrival direction. In addition, light arriving from a direction different from the arrival direction of the spatial optical signal from the communication target can be regarded as a noise component or a disturbance component. Therefore, according to the present example embodiment, since the light of the noise component or the disturbance component is not received, the spatial optical signal from the communication target can be more efficiently received.

### Fourth Example Embodiment

Next, a light-receiving device according to a fourth example embodiment will be described with reference to the drawings. The light-receiving device of the present example embodiment includes a liquid-crystal lens that diffracts and reflects the optical signal condensed by the condenser lens. In the present example embodiment, an example will be described in which an elongated liquid-crystal lens set according to the arrival direction of the spatial optical signal is included, but a liquid-crystal lens (first example embodiment) capable of coping with a spatial optical signal arriving from an arbitrary direction may be applied.

### Configuration

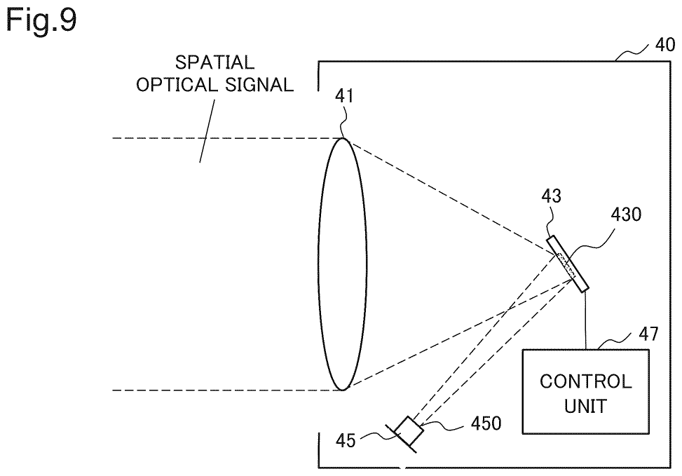

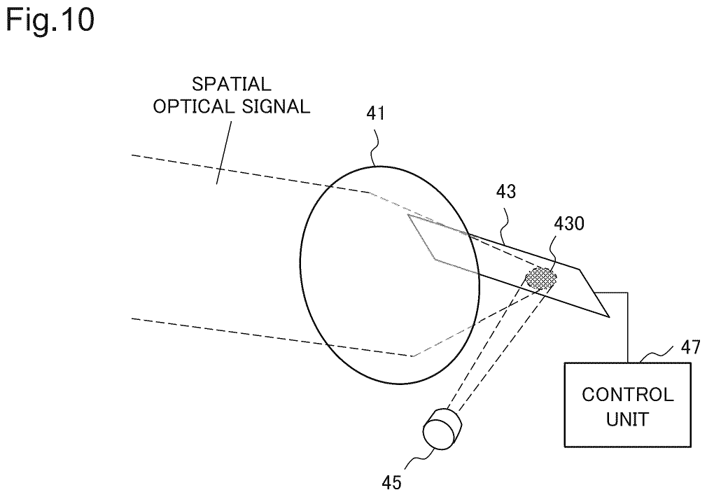

FIG. 9 is a conceptual diagram illustrating an example of a configuration of the light-receiving device 40 of the present example embodiment. The light-receiving device 40 includes a condenser lens 41, a liquid-crystal lens 43, a light-receiving element 45, and a control unit 47. FIG. 9 is a view of the internal configuration of the light-receiving device 40 as viewed from the lateral direction. FIG. 10 is a conceptual diagram for describing an example of a trajectory of light received by the light-receiving device 40. FIG. 10 is a perspective view of the internal configuration of the light-receiving device 40 as viewed obliquely in front of the incident surface side.

The condenser lens 41 is an optical element that condenses a spatial optical signal arriving from the outside. The optical signal condensed by the condenser lens 41 is condensed toward the incident surface of the liquid-crystal lens 43. The condenser lens 41 has the same configuration as the condenser lens 11 of the first example embodiment. The condenser lens 41 may be configured to condense light according to the shape of the liquid-crystal lens 43.

The liquid-crystal lens 43 (also referred to as a variable lens) is disposed at a subsequent stage of the condenser lens 41. The liquid-crystal lens 43 is a reflective diffractive optical element. The liquid-crystal lens 43 has a reflective surface that diffracts and reflects light in a wavelength band of an optical signal. The reflective surface of the liquid-crystal lens 43 is disposed such that the optical signal emitted from the condenser lens 41 is reflected toward the light-receiving part 450 of the light-receiving element 45. For example, the liquid-crystal lens 43 is realized by a spatial light modulator using ferroelectric liquid crystal, homogeneous liquid crystal, vertical alignment liquid crystal, or the like. For example, the liquid-crystal lens 43 is realized by liquid crystal on silicon (LCOS). For example, the liquid-crystal lens 43 may be constructed with a micro electro mechanical system (MEMS). The refractive index of the reflective surface of the liquid-crystal lens 43 changes according to the applied voltage.

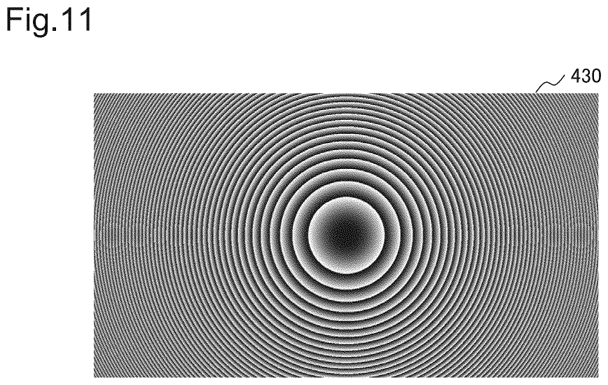

The lens region 430 is formed on the reflective surface of the liquid-crystal lens 43 under the control of the control unit 47. A virtual lens pattern (hereinafter, referred to as a virtual lens image) is displayed in the lens region 430 formed on the reflective surface of the liquid-crystal lens 43 under the control of the control unit 47. FIG. 11 is a conceptual diagram illustrating an example of a virtual lens image. The virtual lens image is a lens pattern for condensing a spatial optical signal at a desired focal length. The wavefront of light can be controlled by phase control, similar to diffraction. When the phase changes to a spherical shape, a spherical difference is generated in the wavefront, and a lens effect is generated. That is, the virtual lens image is a pattern that changes the phase of incident light (spatial optical signal) on the reflective surface of the liquid-crystal lens 43 into a spherical shape and generates a lens effect of condensing light at a predetermined focal length. For example, in order to condense the optical signal derived from the spatial optical signal on the light-receiving part 450 of the light-receiving element 45, a virtual lens image that condense the optical signal toward the light-receiving part 450 may be displayed on the reflective surface of the liquid-crystal lens 43.

The liquid-crystal lens 43 is formed in a shape corresponding to the arrival direction of the spatial optical signal. For example, when the spatial optical signal arrives from the horizontal direction, the liquid-crystal lens 43 is formed in a shape having a long axis in the horizontal direction and a short axis in the vertical direction. For example, when the spatial optical signal arrives from the vertical direction, the liquid-crystal lens 43 is formed in a shape having a long axis in the vertical direction and a short axis in the horizontal direction. The shape of the liquid-crystal lens 43 may be formed according to the arrival direction of the spatial optical signal. When the liquid-crystal lens is configured to correspond to a spatial optical signal arriving from an arbitrary direction, the shape of the liquid-crystal lens 43 is not particularly limited.

The optical signal condensed by the condenser lens 41 is incident on the reflective surface of the liquid-crystal lens 43 on which the virtual lens image is displayed. The optical signal incident on the reflective surface of the liquid-crystal lens 43 is diffracted and reflected toward a predetermined region. An emission direction of the optical signal diffracted/reflected by the reflective surface of the liquid-crystal lens 43 is controlled according to the control of the control unit 47, and the optical signal is emitted toward the light-receiving part 450 of the light-receiving element 45.

The light-receiving element 45 is disposed at a subsequent stage of the liquid-crystal lens 43. The light-receiving element 45 includes a light-receiving part 450 that receives the optical signal reflected by the liquid-crystal lens 43. The light-receiving element 45 is disposed such that the optical signal reflected by the liquid-crystal lens 43 is received by the light-receiving part 450. The optical signal reflected by the liquid-crystal lens 43 is received by the light-receiving part 450 of the light-receiving element 45. The light-receiving element 45 converts the received optical signal into an electric signal. The light-receiving element 45 outputs the converted electric signal to a decoder (not illustrated). The light-receiving element 45 has the same configuration as the light-receiving element 15 of the first example embodiment.

The control unit 47 controls the liquid-crystal lens 43 such that the optical signal incident on the reflective surface of the liquid-crystal lens 43 is reflected toward the position (predetermined region) where the light-receiving part 450 of the light-receiving element 45 is disposed. The control unit 47 forms the lens region 430 on the reflective surface of the liquid-crystal lens 43 according to the arrival direction of the spatial optical signal. For example, the control unit 47 changes the refractive index of the reflective surface by changing the voltage applied to the reflective surface of the liquid-crystal lens 43 so that the optical signal is reflected toward the light-receiving part 450 of the light-receiving element 45. When the refractive index of the reflective surface is changed, the optical signal emitted to the reflective surface is appropriately diffracted based on the refractive index of each part of the reflective surface.

The control unit 47 controls the liquid-crystal lens 43 such that the optical signal incident on the incident surface of the liquid-crystal lens 43 is emitted toward the position (predetermined region) where the light-receiving part 450 of the light-receiving element 45 is disposed. For example, the control unit 47 is realized by a microcomputer including a processor and a memory. For example, the control unit 47 forms the lens region 430 at a desired position of the liquid-crystal lens 43 by controlling a voltage applied to the reflective surface of the liquid-crystal lens 43. The control unit 47 changes the refractive index of the lens region 430 by adjusting the voltage applied to the reflective surface of the liquid-crystal lens 43. When the refractive index of the lens region 430 is changed, the spatial optical signal incident on the liquid-crystal lens 43 is appropriately diffracted according to the refractive index of the lens region 430. That is, the spatial optical signal incident on the liquid-crystal lens 43 is diffracted according to the optical characteristics of the lens region 430. For example, the control unit 47 displays a virtual lens image for condensing a spatial optical signal at a desired focal length on the reflective surface of the liquid-crystal lens 43. The method for driving the liquid-crystal lens 43 by the control unit 47 is not limited to the method described herein.

### Modification

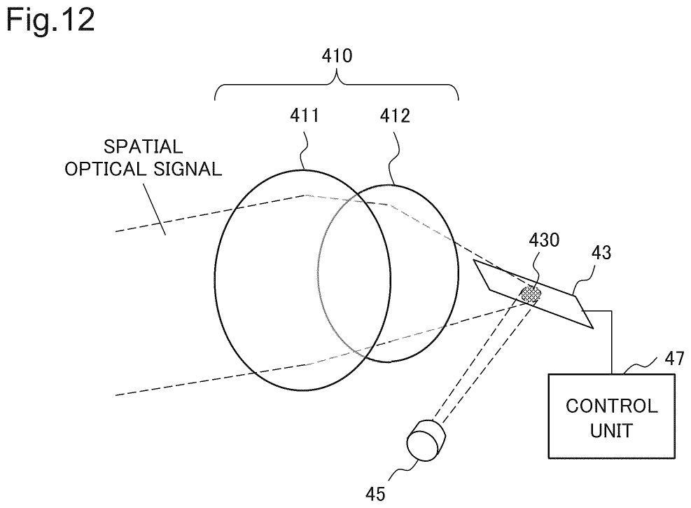

FIG. 12 is a conceptual diagram for describing a modification of the light-receiving device 40 of the present example embodiment. The light-receiving device of the modification of FIG. 12 includes a reduction optical system 410. The reduction optical system 410 has a structure in which the first condenser lens 411 and the second condenser lens 412 are combined. The second condenser lens 412 preferably has a higher refractive index than the first condenser lens 411. FIG. 12 illustrates an example in which the first condenser lens 411 and the second condenser lens 412 are combined, but the number of lenses included in the reduction optical system 410 may be three or more.

The first condenser lens 411 condenses the spatial optical signal toward the second condenser lens 412. The second condenser lens 412 condenses the light condensed by the first condenser lens 411 toward the liquid-crystal lens 43. The light (also referred to as an optical signal) condensed by the second condenser lens 412 is condensed by the liquid-crystal lens 43 and received by the light-receiving element 45.

According to the present modification, the focal range of the optical signal can be reduced as compared with the case of using a single condenser lens. Therefore, according to the present modification, the size of the liquid-crystal lens 43 can be reduced. Furthermore, according to the present modification, since the focal length of the reduction optical system can be made smaller than that of condensing light with a single condenser lens, the size of the light-receiving device can be reduced.

As described above, the light-receiving device according to the present example embodiment includes the condenser lens, the liquid-crystal lens, the control unit, and the light-receiving element. The condenser lens receives a spatial optical signal. The liquid-crystal lens (variable lens) is a reflective liquid-crystal lens. In the liquid-crystal lens, a lens region is formed at an arbitrary position. The liquid-crystal lens focuses an optical signal derived from a spatial optical signal condensed by the condenser lens in a lens region. The control unit adjusts a voltage applied to the liquid-crystal lens to form a lens region at a desired position of the liquid-crystal lens. The control unit controls an emission direction of the optical signal emitted from the liquid-crystal lens. The light-receiving element is disposed with the light-receiving part facing the liquid-crystal lens. The light-receiving element receives the optical signal focused by the liquid-crystal lens.

According to the light-receiving device of the present example embodiment, the optical signal condensed by the condenser lens is reflected by the reflective liquid-crystal lens so as to be guided to the predetermined region, whereby the spatial optical signal arriving from an arbitrary direction can be efficiently received. In the transmissive liquid-crystal lens, the intensity of the transmitted optical signal decreases due to the lattice between the pixels of the liquid crystal. On the other hand, in the reflective liquid-crystal lens, the intensity of the incident optical signal does not decrease. Therefore, according to the light-receiving device of the present example embodiment, the light-receiving efficiency of the spatial optical signal can be improved as compared with the case of using the transmission type liquid-crystal lens. In addition, according to the light-receiving device of the present example embodiment, since the traveling direction of the optical signal is bent by using the reflective liquid-crystal lens, the size of the light-receiving device can be reduced as compared with the case of using the transmissive liquid-crystal lens.

In one aspect of the present example embodiment, the liquid-crystal lens (variable lens) is a liquid crystal on silicon (LCOS). The control unit causes a virtual lens image that focuses the spatial optical signal toward the light-receiving part of the light-receiving element to be displayed at a desired position on the display part of the LCOS. According to the present aspect, by displaying the virtual lens at a desired position on the display part of the LCOS, the optical signal can be efficiently focused on the light-receiving part of the light-receiving element.

A light-receiving device according to one aspect of the present example embodiment includes a reduction optical system in which a plurality of the condenser lenses are combined. For example, when LCOS is used as the liquid-crystal lens, it is required to reduce the condensing region according to the size of LCOS. According to the present aspect, since the focal length can be shortened by combining the plurality of the condenser lenses, even a liquid-crystal lens having a small light-receiving surface can receive an optical signal based on a spatial optical signal arriving from an arbitrary direction.

### Fifth Example Embodiment

Next, a reception device according to a fifth example embodiment will be described with reference to the drawings. A reception device of the present example embodiment includes a decoder that decodes an optical signal received by a light-receiving element. In the present example embodiment, an example in which an elongated liquid-crystal lens set according to the arrival direction of the spatial optical signal is included will be described, but a liquid-crystal lens capable of coping with a spatial optical signal arriving from an arbitrary direction may be applied. A reflective liquid-crystal lens as in the fourth example embodiment may be applied to the reception device of the present example embodiment. The reception device of the present example embodiment may include the imaging unit of the second example embodiment.

### Configuration

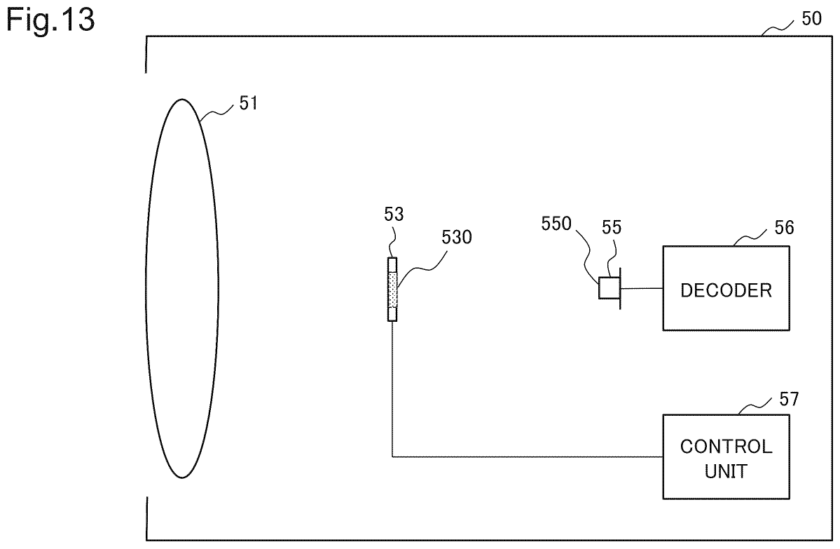

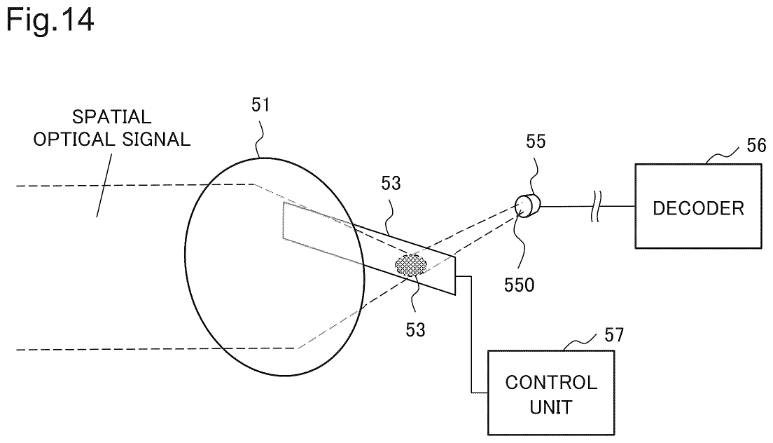

FIG. 13 is a conceptual diagram illustrating an example of a configuration of the reception device 50 according to the present example embodiment. The reception device 50 includes a condenser lens 51, a liquid-crystal lens 53, a light-receiving element 55, a decoder 56, and a control unit 57. FIG. 13 is a view illustrating an internal configuration of the reception device 50 when the internal configuration is viewed from the lateral direction. FIG. 14 is a conceptual diagram for describing an example of a trajectory of light received by the reception device 50. FIG. 14 is a perspective view of the internal configuration of the reception device 50 as viewed obliquely in front of the incident surface side. The position of the decoder 56 is not particularly limited. The decoder 56 may be disposed inside the reception device 50 or may be disposed outside the reception device 50.

The condenser lens 51 is an optical element that condenses a spatial optical signal arriving from the outside. The optical signal condensed by the condenser lens 51 is condensed toward the incident surface of the liquid-crystal lens 53. The condenser lens 51 has the same configuration as the condenser lens 11 of the first example embodiment. The condenser lens 51 may be configured to condense the optical signal according to the shape of the liquid-crystal lens 53.

The liquid-crystal lens 53 (also referred to as a variable lens) is disposed at a subsequent stage of the condenser lens 51. The liquid-crystal lens 53 is disposed such that an incident surface thereof faces an emission surface of the condenser lens 51. For example, as in the third example embodiment, the liquid-crystal lens 53 is set to a shape corresponding to the arrival direction of the spatial optical signal. The liquid-crystal lens 53 may be configured to correspond to a spatial optical signal arriving from an arbitrary direction as in the first example embodiment. The optical signal incident from the incident surface of the liquid-crystal lens 53 is focused in the lens region 530 formed under the control of the control unit 57, and is emitted toward the light-receiving part 550 of the light-receiving element 55. The liquid-crystal lens 53 has the same configuration as the liquid-crystal lens 33 of the third example embodiment. The liquid-crystal lens 53 may be a reflective type as in the fourth example embodiment. Since the liquid-crystal lens 53 is similar to any one of the first to fourth example embodiments, a detailed description thereof will be omitted.

The light-receiving element 55 is disposed at a subsequent stage of the liquid-crystal lens 53. The light-receiving element 55 includes a light-receiving part 550 that receives the optical signal focused by the liquid-crystal lens 53. The light-receiving element 55 is disposed such that the light-receiving part 550 faces the emission surface of the liquid-crystal lens 53. The light-receiving element 55 is disposed such that the light-receiving part 550 is located in a predetermined region. The optical signal emitted from the liquid-crystal lens 53 is received by the light-receiving part 550 of the light-receiving element 55 located in the predetermined region. The light-receiving element 55 converts the received optical signal into an electric signal. The light-receiving element 55 outputs the converted electric signal to the decoder 56. The light-receiving element 55 has the same configuration as the light-receiving element 15 of the first example embodiment.

The decoder 56 acquires a signal output from the light-receiving element 55. The decoder 56 amplifies the signal from the light-receiving element 55. The decoder 56 decodes the amplified signal and analyzes a signal from the communication target. The signal decoded by the decoder 56 is used for any purpose. The use of the signal decoded by the decoder 56 is not particularly limited.

The control unit 57 controls the liquid-crystal lens 53 such that the optical signal incident on the incident surface of the liquid-crystal lens 53 is emitted toward the position (predetermined region) where the light-receiving part 550 of the light-receiving element 55 is disposed. The control unit 57 causes the liquid-crystal lens 53 to form the lens region 530 according to the arrival direction of the spatial optical signal. The control unit 57 has the same configuration as the control unit 17 of the first example embodiment.

[Decoder]

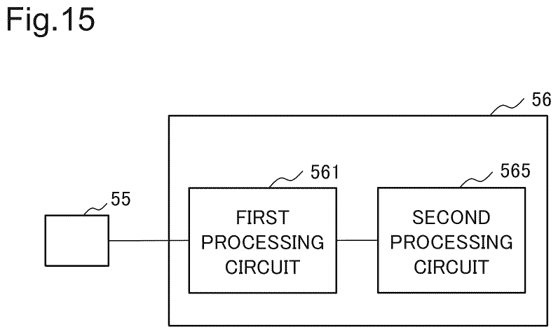

Next, an example of a detailed configuration of the decoder 56 included in the reception device 50 will be described with reference to the drawings. FIG. 15 is a block diagram illustrating an example of a configuration of the decoder 56. The decoder 56 includes a first processing circuit 561 and a second processing circuit 565.

The first processing circuit 561 acquires a signal from the light-receiving element 55. The first processing circuit 561 amplifies the selected signal. The first processing circuit 561 may selectively pass a signal in the wavelength band of the spatial optical signal. For example, the first processing circuit 561 may cut a signal derived from ambient light such as sunlight among the acquired signals and selectively pass a signal of a high frequency component corresponding to the wavelength band of the spatial optical signal. The first processing circuit 561 outputs the amplified signal to the second processing circuit 565.

The second processing circuit 565 acquires a signal from the first processing circuit 561. The second processing circuit 565 decodes the acquired signal. The second processing circuit 565 may be configured to perform some signal processing on the decoded signal, or may be configured to output the signal to an external signal processing device or the like (not illustrated). In the case of decoding a plurality of signals derived from spatial light from a plurality of communication targets, the second processing circuit may be configured to read the signals in a time division manner.

As described above, the reception device according to the present example embodiment includes the condenser lens, the liquid-crystal lens, the control unit, the light-receiving element, and the decoder. The condenser lens receives a spatial optical signal. In the liquid-crystal lens (variable lens), a lens region is formed at an arbitrary position. The liquid-crystal lens focuses an optical signal derived from a spatial optical signal condensed by the condenser lens in a lens region. The control unit forms a lens region at a desired position of the liquid-crystal lens. The control unit controls an emission direction of the optical signal emitted from the liquid-crystal lens. The light-receiving element is disposed with the light-receiving part facing the liquid-crystal lens. The light-receiving element receives the optical signal focused by the liquid-crystal lens. The decoder decodes a signal based on the optical signal received by the light-receiving element.

According to the reception device of the present example embodiment, it is possible to decode a signal based on a spatial optical signal arriving from an arbitrary direction. For example, according to the reception device of the present example embodiment, a single-channel reception device can be realized. For example, according to the reception device of the present example embodiment, a multi-channel reception device can be realized by decoding a signal based on a spatial optical signal in a time division manner.

### Sixth Example Embodiment

Next, a reception device according to a sixth example embodiment will be described with reference to the drawings. The reception device of the present example embodiment includes a plurality of decoders that decode the optical signal received by the light-receiving element. In the present example embodiment, an example in which an elongated liquid-crystal lens set according to the arrival direction of the spatial optical signal is included will be described, but a liquid-crystal lens capable of coping with a spatial optical signal arriving from an arbitrary direction may be applied. A reflective liquid-crystal lens as in the fourth example embodiment may be applied to the reception device of the present example embodiment. The reception device of the present example embodiment may include the imaging unit of the second example embodiment.

### Configuration

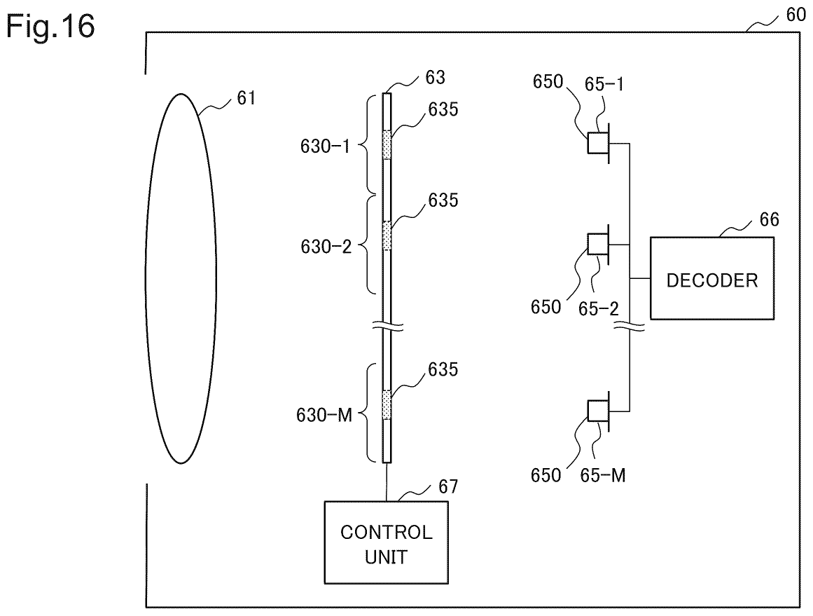

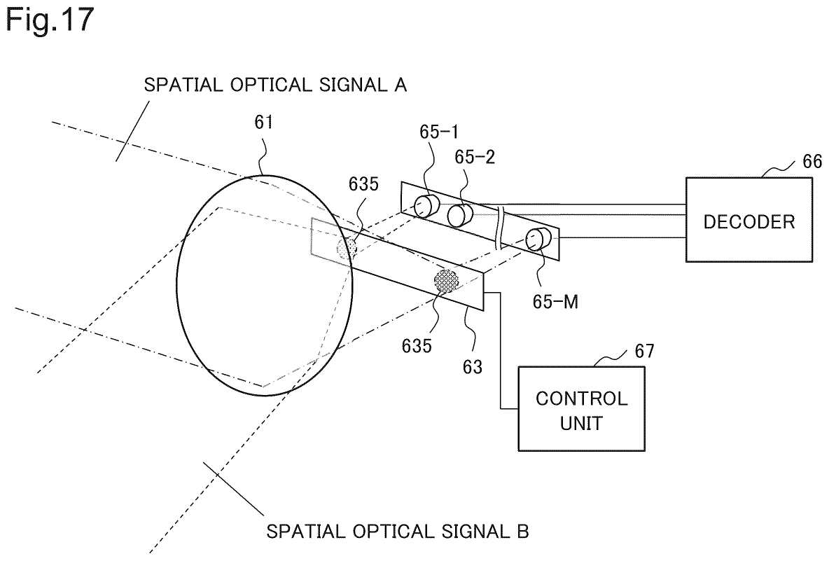

FIG. 16 is a conceptual diagram illustrating an example of a configuration of the reception device 60 according to the present example embodiment. The reception device 60 includes a condenser lens 61, a liquid-crystal lens 63, a plurality of light-receiving elements 65-1 to M, a decoder 66, and a control unit 67 (M is a natural number of 2 or more; and). FIG. 16 is a plan view of the internal configuration of the reception device 60 as viewed from above. FIG. 17 is a conceptual diagram for describing an example of a trajectory of light received by the reception device 60. FIG. 17 is a perspective view of the internal configuration of the reception device 60 as viewed obliquely in front of the incident surface side. The position of the decoder 66 is not particularly limited. The decoder 66 may be disposed inside the reception device 60 or may be disposed outside the reception device 60.

The condenser lens 61 is an optical element that condenses a spatial optical signal arriving from the outside. The optical signal condensed by the condenser lens 61 is condensed toward the incident surface of the liquid-crystal lens 63. The condenser lens 61 has the same configuration as the condenser lens 11 of the first example embodiment. The condenser lens 61 may be configured to condense light according to the shape of the liquid-crystal lens 63.

The liquid-crystal lens 63 (also referred to as a variable lens) is disposed at a subsequent stage of the condenser lens 61. The liquid-crystal lens 63 is disposed such that an incident surface thereof faces an emission surface of the condenser lens 61. The liquid-crystal lens 63 has the same configuration as the liquid-crystal lens 33 of the third example embodiment. For example, as in the third example embodiment, the liquid-crystal lens 63 is set to a shape corresponding to the arrival direction of the spatial optical signal. The liquid-crystal lens 63 may be configured to correspond to a spatial optical signal arriving from an arbitrary direction as in the first example embodiment.

The optical signal condensed by the condenser lens 61 is incident on the incident surface of the liquid-crystal lens 63. A plurality of light beam control regions 630-1 to M are set in the liquid-crystal lens 63. Each of the plurality of light beam control regions 630-1 to M set in the liquid-crystal lens 63 is associated with each of the plurality of light-receiving elements 65-1 to M. In each of the plurality of light beam control regions 630-1 to M, a lens region 635 is formed under the control of the control unit 67. The optical signal incident on each of the plurality of light beam control regions 630-1 to M is diffracted by the lens region 635 formed in each light beam control region 630. The optical signal diffracted by the lens region 635 formed in each light beam control region 630 is focused toward a predetermined region where the light-receiving parts 650 of the light-receiving elements 65-1 to M corresponding to each light beam control region 630 are arranged.

In the example of FIG. 17, the spatial optical signal A and the spatial optical signal B arriving from different directions are incident on the condenser lens 61. The optical signals derived from the spatial optical signal A and the spatial optical signal B are condensed by the condenser lens 61 and are incident on different light beam control regions 630 of the liquid-crystal lens 63. The optical signal incident from the incident surface of the liquid-crystal lens 63 is focused in the lens region 635 formed in the different light beam control region 630 according to the control of the control unit 67, and is emitted toward the light-receiving part 650 of the light-receiving element 65. As a result, the optical signal derived from the spatial optical signal A and the optical signal derived from the spatial optical signal B are received by different light-receiving elements 65.

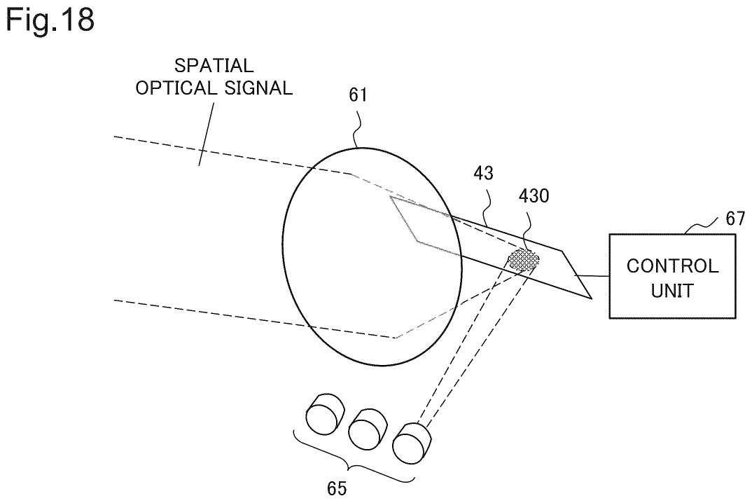

FIG. 18 illustrates a configuration in which the reflective liquid-crystal lens 43 of the fourth example embodiment is arranged instead of the liquid-crystal lens 63 of the present example embodiment. In the example of FIG. 18, the optical signal derived from the spatial optical signal is condensed by the condenser lens 61 and is incident on the light beam control region on the reflective surface of the liquid-crystal lens 43. The optical signal incident from the incident surface of the liquid-crystal lens 43 is focused in the lens region 430 formed under the control of the control unit 67, and is emitted toward the light-receiving part 650 of the light-receiving element 65. As a result, the optical signal derived from the spatial optical signal is received by the light-receiving element 65 associated with the light beam control element.

The plurality of light-receiving elements 65-1 to M are arranged at a subsequent stage of the liquid-crystal lens 63. Each of the plurality of light-receiving elements 65-1 to M includes a light-receiving part 650 that receives the optical signal emitted from the liquid-crystal lens 63. The plurality of light-receiving elements 65-1 to M are disposed such that the emission surface of the liquid-crystal lens 63 and the light-receiving part 650 face each other. The light-receiving part 650 of each of the plurality of light-receiving elements 65-1 to M is arranged to face each of the plurality of light beam control regions 630-1 to M. The optical signal emitted from each of the plurality of light beam control regions 630-1 to M is received by the light-receiving part 650 of each of the plurality of light-receiving elements 65-1 to M. Each of the plurality of light-receiving elements 65-1 to M converts the received optical signal into an electric signal (hereinafter, also referred to as a signal). Each of the plurality of light-receiving elements 65-1 to M outputs the converted signal to the decoder 66. Each of the plurality of light-receiving elements 65-1 to M has the same configuration as the light-receiving element 15 of the first example embodiment.

The decoder 66 acquires a signal output from each of the plurality of light-receiving elements 65-1 to M. The decoder 66 amplifies a signal from each of the plurality of light-receiving elements 65-1 to M. The decoder 66 decodes the amplified signal and analyzes a signal from the communication target. For example, the decoder 66 collectively analyzes the signals of the plurality of light-receiving elements 65-1 to M. In a case where the signals of the plurality of light-receiving elements 65-1 to M are collectively analyzed, it is possible to realize the single-channel reception device 60 that communicates with a single communication target. For example, the decoder 66 individually analyzes a signal for each of the plurality of light-receiving elements 65-1 to M. In a case where signals are individually analyzed for each of the plurality of light-receiving elements 65-1 to M, it is possible to realize the multi-channel reception device 60 that simultaneously communicates with a plurality of communication targets. The signal decoded by the decoder 66 is used for any purpose. The use of the signal decoded by the decoder 66 is not particularly limited.

[Decoder]

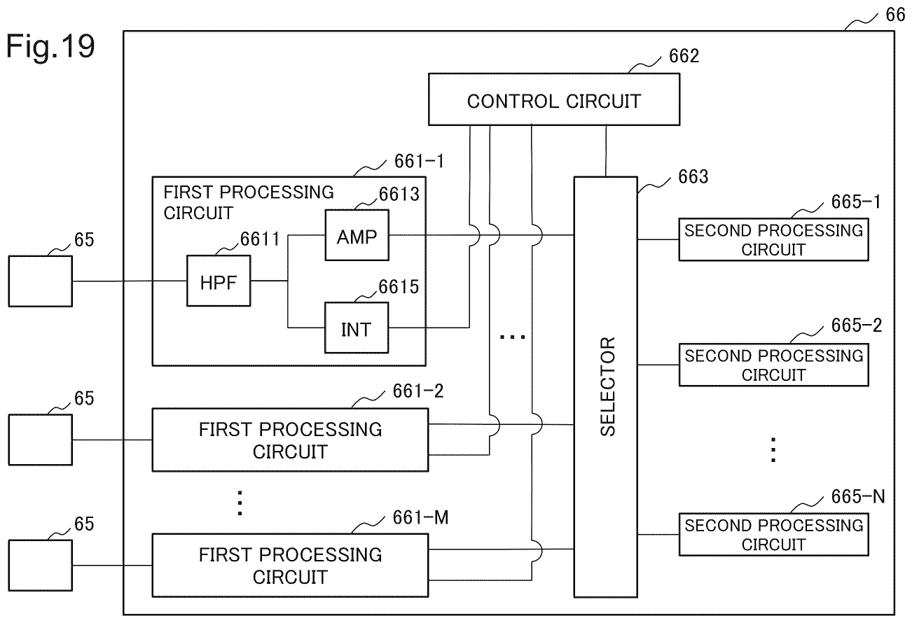

Next, an example of a detailed configuration of the decoder 66 included in the reception device 60 will be described with reference to the drawings. FIG. 19 is a block diagram illustrating an example of a configuration of the decoder 66. The decoder 66 includes a plurality of first processing circuits 661-1 to M, a control circuit 662, a selector 663, and a plurality of second processing circuits 665-1 to N (M and N are natural numbers). In FIG. 19, only the internal configuration of the first processing circuit 661-1 among the plurality of first processing circuits 661-1 to M is illustrated, but the internal configuration of the plurality of first processing circuits 661-2 to M is also similar to that of the first processing circuit 661-1.

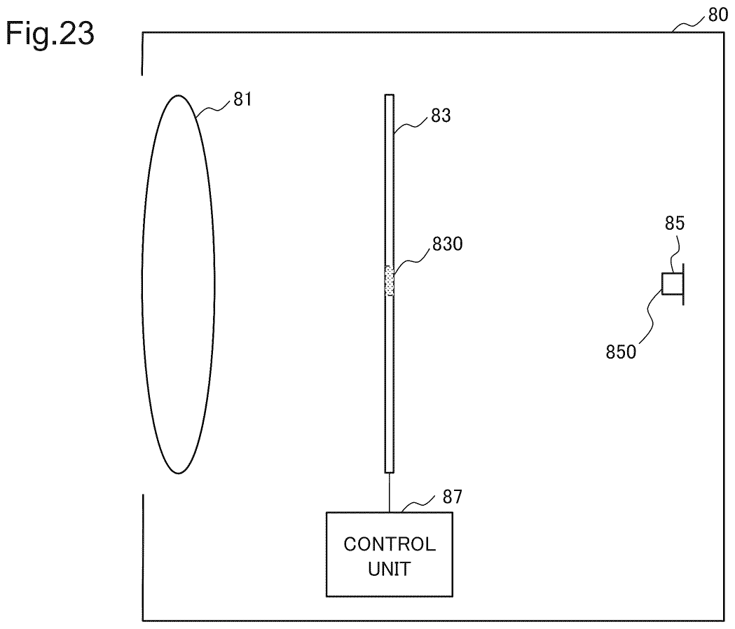

The first processing circuit 661 is associated with any one of the plurality of light-receiving elements 65-1 to M. The first processing circuit 661 includes a high-pass filter 6611, an amplifier 6613, and an integrator 6615. In FIG. 23, the high-pass filter 6611 is referred to as a high-path filter (HPF), the amplifier 6613 is referred to as an amplifier (AMP), and the integrator 6615 is referred to as an integrator (INT). The high-pass filter 6611 of each of the plurality of first processing circuits 661-1 to M acquires a signal from any one of the light-receiving elements 65-1 to M associated with each of the plurality of first processing circuits 661-1 to M. Each of the plurality of light-receiving elements 65-1 to M and each of the plurality of first processing circuits 661-1 to M corresponding thereto constitute one unit. The signal having passed through the high-pass filter 6611 of each of the plurality of first processing circuits 661-1 to M is input in parallel to the amplifier 6613 and the integrator 6615.

The high-pass filter 6611 acquires a signal from the light-receiving element 65. The high-pass filter 6611 selectively passes a signal of a high frequency component corresponding to the wavelength band of the spatial optical signal among the acquired signals. The high-pass filter 6611 cuts off a signal derived from ambient light such as sunlight. Instead of the high-pass filter 6611, a band-pass filter that selectively passes a signal in a wavelength band of a spatial optical signal may be configured. When the light-receiving element 65 is saturated with intense sunlight, an optical signal cannot be read. Therefore, a color filter that selectively passes the light in the wavelength band of the spatial optical signal may be installed in the preceding stage of the light-receiving part of the light-receiving element 65. The signal that has passed through the high-pass filter 6611 is supplied to the amplifier 6613 and the integrator 6615.

The amplifier 6613 acquires the signal output from the high-pass filter 6611. The amplifier 6613 amplifies the acquired signal. The amplifier 6613 outputs the amplified signal to the selector 663. Among the signals output to the selector 663, the signal to be received is allocated to any one of the plurality of second processing circuits 665-1 to N under the control of the control circuit 662. The signal to be received is a spatial optical signal from a communication device (not illustrated) to be communicated. A signal from the light-receiving element 65 that is not used for receiving the spatial optical signal is not output to the second processing circuit 665.

The integrator 6615 acquires the signal output from the high-pass filter 6611. The integrator 6615 integrates the acquired signal. The integrator 6615 outputs the integrated signal to the control circuit 662. The integrator 6615 is disposed to measure the intensity of the spatial optical signal received by the light-receiving element 65. In the present example embodiment, the spatial optical signal in a state in which the beam diameter is spread is received by the surface on the incident surface of the condenser lens 61, thereby increasing the speed of searching for the communication target. Since the intensity of the spatial optical signal received in a state where the beam diameter is not narrowed is weak as compared with a case where the beam diameter is narrowed, it is difficult to measure the voltage of the signal amplified only by the amplifier 6613. By using the integrator 6615, for example, the voltage of the signal can be increased to a level at which the voltage can be measured by integrating several milliseconds (msec) to several tens of milliseconds.

The control circuit 662 acquires a signal output from the integrator 6615 included in each of the plurality of first processing circuits 661-1 to M. In other words, the control circuit 662 acquires a signal derived from an optical signal received by each of the plurality of light-receiving elements 65-1 to M. For example, the control circuit 662 compares the readings of the signals from the plurality of light-receiving elements 65 adjacent to each other. The control circuit 662 selects the light-receiving element 65 having the maximum signal intensity according to the comparison result. The control circuit 662 controls the selector 663 so as to allocate the signal derived from the selected light-receiving element 65 to one of the plurality of second processing circuits 665-1 to N.

Selecting the light-receiving element 65 by the control circuit 662 corresponds to estimating the arrival direction of the spatial optical signal. That is, the control circuit 662 selecting the light-receiving element 65 corresponds to specifying the communication device of the light transmission source of the spatial optical signal. Further, allocating the signal from the light-receiving element 65 selected by the control circuit 662 to any one of the plurality of second processing circuits corresponds to associating the specified communication target with the light-receiving element 65 that receives the spatial optical signal from the communication target. That is, the control circuit 662 specifies the communication device of the light transmission source of the optical signal (spatial optical signal) based on the optical signal received by the plurality of light-receiving elements 650-1 to M. In a case where the position of the communication target is specified in advance, the signals output from the light-receiving elements 65-1 to M may be decoded as they are without performing the processing of estimating the arrival direction of the spatial optical signal.

The signal amplified by the amplifier 6613 included in each of the plurality of first processing circuits 661-1 to M is input to the selector 663. The selector 663 outputs a signal to be received among the input signals to any of the plurality of second processing circuits 665-1 to N according to the control of the control circuit 662. A signal that is not a reception target is not output from the selector 663.

A signal from any one of the plurality of light-receiving elements 65-1 to N allocated by the control circuit 662 is input to the plurality of second processing circuits 665-1 to N. Each of the plurality of second processing circuits 665-1 to N decodes the input signal. Each of the plurality of second processing circuits 665-1 to N may be configured to perform some signal processing on the decoded signal, or may be configured to output the signal to an external signal processing device or the like (not illustrated).

The selector 663 selects a signal derived from the light-receiving element 65 selected by the control circuit 662, whereby one second processing circuit 665 is allocated to one communication target. That is, the control circuit 662 allocates the signals derived from the spatial optical signals from the plurality of communication targets received by the plurality of light-receiving elements 65-1 to M to one of the plurality of second processing circuits 665-1 to N. As a result, the reception device 60 can simultaneously read signals derived from spatial optical signals from a plurality of communication targets on individual channels. In the case of the fifth example embodiment, in order to simultaneously communicate with a plurality of communication targets, spatial optical signals from the plurality of communication targets are read in time division in one channel. On the other hand, in the method of the present example embodiment, since spatial optical signals from a plurality of communication targets are simultaneously read in a plurality of channels, the transmission speed is improved. The method of the present example embodiment may also be configured to receive signals in a time-division manner according to the situation.

For example, the scan of the communication target may be performed as a primary scan, and the arrival direction of the spatial optical signal may be specified with coarse accuracy. Then, secondary scanning with fine accuracy may be performed in the specified direction to specify a more accurate position of the communication target. When communication with the communication target becomes possible, an accurate position of the communication target can be determined by exchanging signals with the communication target. When the position of the communication target is specified in advance, the process of specifying the position of the communication target may be omitted.

As described above, the reception device according to the present example embodiment includes the condenser lens, the liquid-crystal lens, the control unit, the plurality of light-receiving elements, and the plurality of decoders. The condenser lens condenses the spatial optical signal. The liquid-crystal lens (variable lens) includes a plurality of light beam control regions respectively associated with a plurality of predetermined regions. In each of the plurality of light beam control regions, a lens region is formed at an arbitrary position. An optical signal derived from the spatial optical signal condensed by the condenser lens is incident on each of the plurality of light beam control regions. The liquid-crystal lens emits the optical signal incident on each of the plurality of light beam control regions toward a predetermined region associated with the light beam control region. Each of the plurality of light-receiving elements is disposed with the light-receiving part facing any of the plurality of predetermined regions. Each of the plurality of light-receiving elements receives the optical signal focused by the lens region formed in the corresponding light beam control region. The control unit forms a lens region at a desired position of each of the plurality of light beam control regions included in the liquid-crystal lens. The control unit controls the emission direction of the optical signal emitted from the plurality of light beam control regions included in the liquid-crystal lens. Each of the plurality of decoders is connected to any one of the plurality of light-receiving elements. The decoder decodes a signal based on the optical signal received by each of the plurality of light-receiving elements.

According to the reception device of the present example embodiment, a signal based on a spatial optical signal arriving from an arbitrary direction can be decoded for each arrival direction. For example, according to the reception device of the present example embodiment, it is possible to realize a multi-channel reception device according to the arrival direction of the spatial optical signal.

### Seventh Example Embodiment

Next, a communication device according to a seventh example embodiment will be described with reference to the drawings. A communication device of the present example embodiment includes the reception device of the fifth example embodiment and a light-transmitting unit that transmits a spatial optical signal according to a received spatial optical signal. Hereinafter, an example of a communication device including a light-transmitting unit including a phase modulation-type spatial light modulator will be described. The communication device of the present example embodiment may include a light-transmitting unit including a light transmission function that is not a phase modulation-type spatial light modulator. In addition, the communication device of the present example embodiment may have a wireless communication function. The communication device of the present example embodiment may have a configuration in which the light-receiving device of the sixth example embodiment and the light-transmitting unit are combined. A reflective liquid-crystal lens as in the fourth example embodiment may be applied to the light-receiving device of the present example embodiment. The light-receiving device of the present example embodiment may include the imaging unit of the second example embodiment.

### Configuration

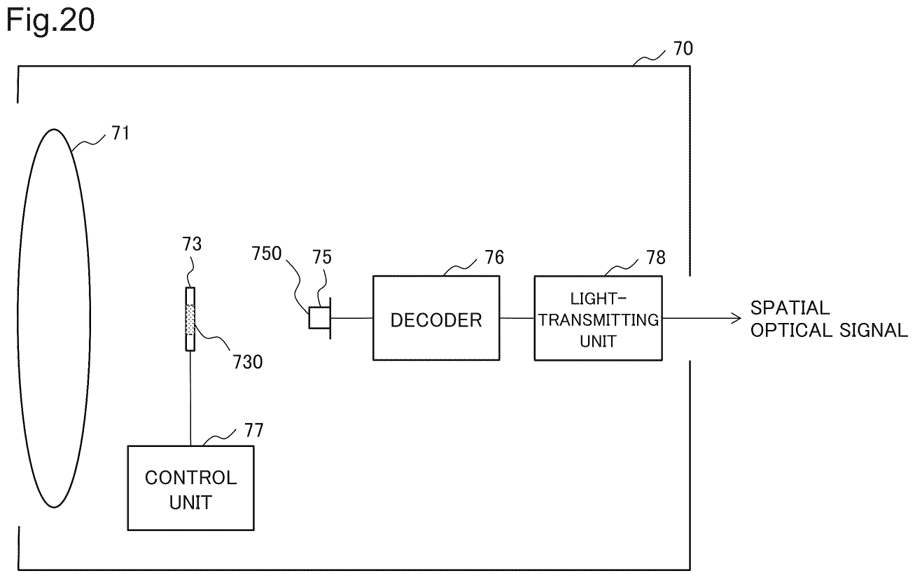

FIG. 20 is a conceptual diagram illustrating an example of a configuration of the communication device 70 according to the present example embodiment. The communication device 70 includes a condenser lens 71, a liquid-crystal lens 73, a light-receiving element 75, a decoder 76, a control unit 77, and a light-transmitting unit 78. FIG. 20 is a diagram of the internal configuration of the communication device 70 as viewed from the lateral direction. The positions of the decoder 76 and the light-transmitting unit 78 are not particularly limited. The decoder 76 and the light-transmitting unit 78 may be arranged inside the communication device 70 or may be arranged outside the communication device 70.

The condenser lens 71 is an optical element that condenses a spatial optical signal arriving from the outside. The optical signal condensed by the condenser lens 71 is condensed toward the incident surface of the liquid-crystal lens 73. The condenser lens 71 has the same configuration as the condenser lens 11 of the first example embodiment. The condenser lens 71 may be configured to condense light according to the shape of the liquid-crystal lens 73.

The liquid-crystal lens 73 (also referred to as a variable lens) is disposed at a subsequent stage of the condenser lens 71. The liquid-crystal lens 73 is disposed such that an incident surface thereof faces an emission surface of the condenser lens 71. For example, as in the third example embodiment, the liquid-crystal lens 73 is set to a shape corresponding to the arrival direction of the spatial optical signal. The liquid-crystal lens 73 may be configured to correspond to a spatial optical signal arriving from an arbitrary direction as in the first example embodiment. The optical signal incident from the incident surface of the liquid-crystal lens 73 is focused in the lens region 730 formed under the control of the control unit 77, and is emitted toward the light-receiving part 750 of the light-receiving element 75. The liquid-crystal lens 73 has the same configuration as the liquid-crystal lens 33 of the third example embodiment. The liquid-crystal lens 73 may be a reflective type as in the fourth example embodiment. The liquid-crystal lens 73 may include a plurality of light beam control regions as in the sixth example embodiment. Since the liquid-crystal lens 73 is similar to any one of the first to sixth example embodiments, a detailed description thereof will be omitted.

The light-receiving element 75 is disposed at a subsequent stage of the liquid-crystal lens 73. The light-receiving element 75 includes the light-receiving part 750 that receives the optical signal emitted from the liquid-crystal lens 73. The light-receiving element 75 is disposed such that the light-receiving part 750 faces the emission surface of the liquid-crystal lens 73. The optical signal emitted from the liquid-crystal lens 73 is received by the light-receiving part 750 of the light-receiving element 75. The light-receiving element 75 converts the received optical signal into an electric signal (hereinafter, also referred to as a signal). The light-receiving element 75 outputs the converted signal to the decoder 76. The light-receiving element 75 has the same configuration as the light-receiving element 15 of the first example embodiment. A plurality of light-receiving elements 75 may be disposed as in the sixth example embodiment.

The decoder 76 acquires a signal output from the light-receiving element 75. The decoder 76 amplifies the signal from the light-receiving element 75. The decoder 76 decodes the amplified signal and analyzes a signal from the communication target. The decoder 76 outputs a control signal for transmitting an optical signal according to the signal analysis result to the light-transmitting unit 78.

The control unit 77 controls the liquid-crystal lens 73 such that the optical signal incident on the incident surface of the liquid-crystal lens 73 is emitted toward the position (predetermined region) where the light-receiving part 750 of the light-receiving element 75 is disposed. The control unit 77 causes the liquid-crystal lens 73 to form the lens region 730 according to the arrival direction of the spatial optical signal. The control unit 77 has the same configuration as the control unit 17 of the first example embodiment.

The light-transmitting unit 78 acquires a control signal from the decoder 76. The light-transmitting unit 78 projects a spatial optical signal corresponding to the control signal. The spatial optical signal projected from the light-transmitting unit 78 is received by a communication target (not illustrated). For example, the light-transmitting unit 78 includes a phase modulation-type spatial light modulator. Furthermore, the light-transmitting unit 78 may include a light transmission function that is not a phase modulation-type spatial light modulator.

[Light-Transmitting Unit]

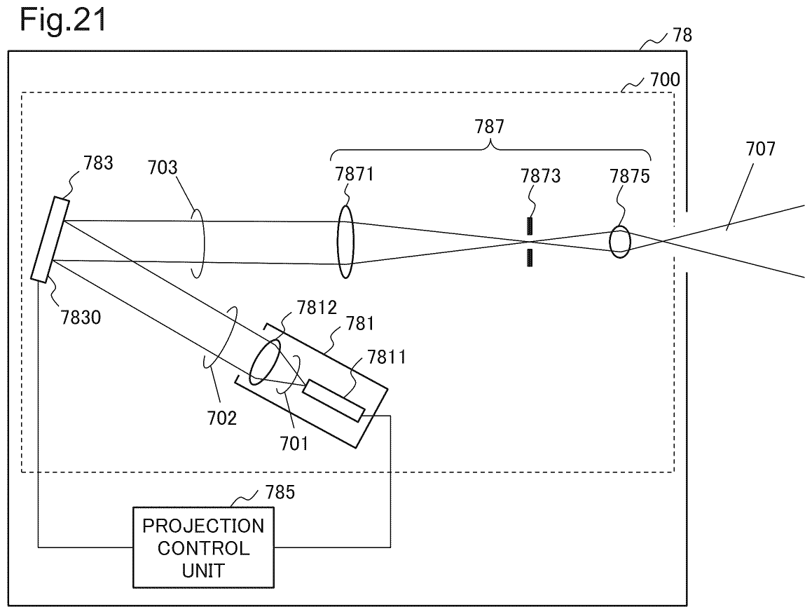

Next, an example of a detailed configuration of the light-transmitting unit 78 will be described with reference to the drawings. FIG. 21 is a conceptual diagram illustrating an example of a detailed configuration of the light-transmitting unit 78. The light-transmitting unit 78 includes an irradiation unit 781, a spatial light modulator 783, a projection control unit 785, and a projection optical system 787. The irradiation unit 781, the spatial light modulator 783, and the projection optical system 787 constitute a light-projecting unit 700. The light-projecting unit 700 projects a spatial optical signal under the control of the projection control unit 785. FIG. 21 is conceptual, and does not accurately represent the positional relationship between the components, the traveling direction of light, and the like.

The irradiation unit 781 emits coherent light 702 having a specific wavelength. As illustrated in FIG. 21, the irradiation unit 781 includes a light source 7811 and a collimator lens 7812. As illustrated in FIG. 21, the light 701 emitted from the irradiation unit 781 passes through the collimator lens 7812 to become coherent light 702, and is incident on the modulation unit 7830 of the spatial light modulator 783. For example, the light source 7811 includes a laser light source. For example, the light source 7811 is configured to emit light 701 in the infrared region. The light source 7811 may be configured to emit light 701 other than the infrared region such as the visible region and the ultraviolet region. The irradiation unit 781 is connected to a power supply (also referred to as a light source driving power supply) driven according to the control of the projection control unit 785. Light 701 is emitted from the light source 7811 in response to the driving of the light source driving power supply.

The spatial light modulator 783 sets a pattern (phase distribution corresponding to the spatial optical signal) for projecting the spatial optical signal in the modulation unit 7830 according to the control of the projection control unit 785. In the present example embodiment, the modulation unit 7830 of the spatial light modulator 783 is irradiated with the light 702 in a state where a predetermined pattern is displayed on the modulation unit 7830. The spatial light modulator 783 emits reflected light (modulated light 703) of the light 702 incident on the modulation unit 7830 toward the projection optical system 787.

In the example of FIG. 21, the incident angle of the light 702 is made non-perpendicular to the incident surface of the modulation unit 7830 of the spatial light modulator 783. That is, in the example of FIG. 21, the emission axis of the light 702 from the irradiation unit 781 is made oblique with respect to the modulation unit 7830 of the spatial light modulator 783, and the light 702 is made incident on the modulation unit 7830 of the spatial light modulator 783 without using the beam splitter. In the configuration of FIG. 21, since attenuation of the light 702 due to passing through the beam splitter does not occur, utilization efficiency of the light 702 can be improved.

The spatial light modulator 783 can be realized by a phase modulation-type spatial light modulator that receives the incidence of the coherent light 702 having the same phase and modulates the phase of the incident light 702. Since the light emitted from the projection optical system 787 using the phase modulation-type spatial light modulator 783 is focus-free, it is not necessary to change the focus for each projection distance even if the light is projected at a plurality of projection distances.

A phase distribution corresponding to the spatial optical signal is displayed on the modulation unit 7830 of the phase modulation-type spatial light modulator 783 according to the drive of the projection control unit 785. The modulated light 703 reflected by the modulation unit 7830 of the spatial light modulator 783 in which the phase distribution is displayed becomes an image in which a kind of diffraction grating forms an aggregate, and an image is formed such that light diffracted by the diffraction grating gathers.

The spatial light modulator 783 is realized by, for example, a spatial light modulator using ferroelectric liquid crystal, homogeneous liquid crystal, vertical alignment liquid crystal, or the like. Specifically, the spatial light modulator 783 can be realized by liquid crystal on silicon (LCOS). For example, the spatial light modulator 783 may be realized by a micro electro mechanical system (MEMS). In the phase modulation-type spatial light modulator 783, the energy can be concentrated on the portion of the image by operating to sequentially switch the portion on which the projection light is projected. Therefore, if the phase modulation-type spatial light modulator 783 is used, if the outputs of the light sources are the same, the display information can be displayed brighter than those of other types.

The projection control unit 785 causes the modulation unit 7830 of the spatial light modulator 783 to display a pattern corresponding to the spatial optical signal according to the control signal from the decoder 76. The projection control unit 785 drives the spatial light modulator 783 such that a parameter that determines a difference between a phase of the light 701 emitted to the modulation unit 7830 of the spatial light modulator 783 and a phase of the modulated light 703 reflected by the modulation unit 7830 changes.

The parameter deciding the difference between the phase of the light 702 emitted to the modulation unit 7830 of the phase modulation-type spatial light modulator 783 and the phase of the modulated light 703 reflected by the modulation unit 7830 is, for example, a parameter regarding optical characteristics such as a refractive index and an optical path length. For example, the projection control unit 785 changes the refractive index of the modulation unit 7830 by changing the voltage applied to the modulation unit 7830 of the spatial light modulator 783. When the refractive index of the modulation unit 7830 is changed, light 702 emitted to the modulation unit 7830 is appropriately diffracted based on the refractive index of each portion of the modulation unit 7830. That is, the phase distribution of the light 702 emitted to the phase modulation-type spatial light modulator 783 is modulated according to the optical characteristics of the modulation unit 7830. The method of driving the spatial light modulator 783 by the projection control unit 785 is not limited to the method described herein.

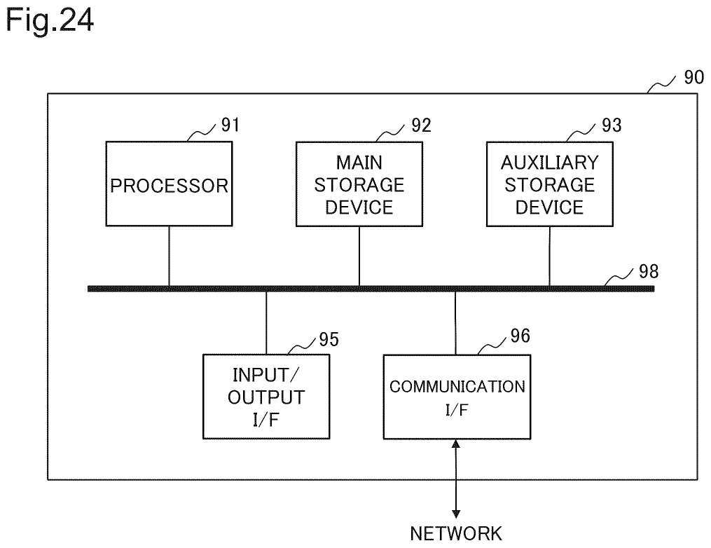

The projection optical system 787 projects the modulated light 703 modulated by the spatial light modulator 783 as projection light 707 (also referred to as a spatial optical signal). As illustrated in FIG. 24, the projection optical system 787 includes a Fourier transform lens 7871, an aperture 7873, and a projection lens 7875. The modulated light 703 modulated by the spatial light modulator 783 is emitted as the projection light 707 by the projection optical system 787. Any of the components of the projection optical system 787 may be omitted as long as an image can be formed in the projection range. For example, in a case where the image corresponding to the phase distribution set in the modulation unit 7830 of the spatial light modulator 783 is enlarged using the virtual lens, the Fourier transform lens 7871 can be omitted. Furthermore, a configuration other than the Fourier transform lens 7871, the aperture 7873, and the projection lens 7875 may be added to the projection optical system 787 as necessary.

The Fourier transform lens 7871 is an optical lens for forming an image formed when the modulated light 703 reflected by the modulation unit 7830 of the spatial light modulator 783 is projected at infinity at a nearby focal point. In FIG. 24, a focal point is formed at the position of the aperture 7873.

The aperture 7873 shields high-order light included in the light focused by the Fourier transform lens 7871, and specifies a range in which the projection light 707 is displayed. The opening of the aperture 7873 is opened smaller than the outermost periphery of the display region at the position of the aperture 7873, and is installed so as to block the peripheral region of the display information at the position of the aperture 7873. For example, the opening of the aperture 7873 is formed in a rectangular shape or a circular shape. The aperture 7873 is preferably provided at the focal position of the Fourier transform lens 7871, but may be shifted from the focal position as long as a function of erasing high-order light can be exhibited.

The projection lens 7875 is an optical lens that enlarges and projects the light focused by the Fourier transform lens 7871. The projection lens 7875 projects the projection light 707 such that the display information corresponding to the phase distribution displayed on the modulation unit 7830 of the spatial light modulator 783 is projected within the projection range. When a line drawing such as a simple symbol is projected, projection light 707 projected from the projection optical system 787 is not uniformly projected toward the entire projection range, but is intensively projected onto a portion such as a character, a symbol, or a frame constituting an image. Therefore, according to the communication device 70 of the present example embodiment, since the emission amount of the light 701 can be substantially reduced, the overall light output can be suppressed. That is, since the communication device 70 can be realized by the small and low-power irradiation unit 781, the light source driving power supply (not illustrated) for driving the irradiation unit 781 can be reduced in output, and the overall power consumption can be reduced.

Furthermore, if the irradiation unit 781 is configured to emit light of a plurality of wavelengths, the wavelength of the light emitted from the irradiation unit 781 can be changed. When the wavelength of the light emitted from the irradiation unit 781 is changed, the color of the spatial optical signal can be multicolored. In addition, if the irradiation unit 781 that simultaneously emits light of different wavelengths is used, communication using spatial optical signals of a plurality of colors becomes possible.

### Application Example

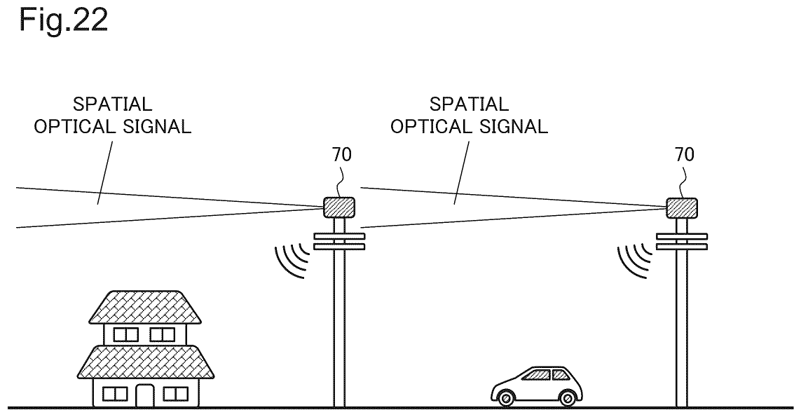

FIG. 22 is a conceptual diagram for describing an application example of the communication device 70 of the present example embodiment. In the present application example, the communication device 70 is disposed on an upper portion of a utility pole. In the present application example, the communication device 70 has a function of performing wireless communication.

There are few obstacles on the upper part of the utility pole. Therefore, the upper portion of the utility pole is suitable for installing the communication device 70. In addition, if the communication device 70 is installed at the same height on the upper portion of the utility pole, the arrival direction of the spatial optical signal is limited to the horizontal direction, so that the shape of the liquid-crystal lens can be elongated in the horizontal direction as in the third to seventh example embodiments. The pair of communication devices 70 that exchange communication is arranged such that at least one communication device 70 receives the spatial optical signal transmitted from the other communication device 70. The pair of communication devices 70 may be arranged to transmit and receive spatial optical signals to and from each other. In a case where the communication network of the spatial optical signal is configured by the plurality of communication devices 70, the communication device 70 positioned in the middle may be arranged to relay the spatial optical signal transmitted from another communication device 70 to another communication device 70.

According to the present application example, communication using a spatial optical signal can be performed between a plurality of communication devices 70 installed on different utility poles. For example, according to the present application example, it is possible to perform communication by wireless communication between a wireless device installed in an automobile, a house, or the like and the communication device 70 according to communication between the communication devices 70 installed on different utility poles.

As described above, the communication device according to the present example embodiment includes the condenser lens, the liquid-crystal lens, the control unit, the light-receiving element, the decoder, and the light-transmitting unit. The condenser lens receives a spatial optical signal. In the liquid-crystal lens (variable lens), a lens region is formed at an arbitrary position. The liquid-crystal lens focuses an optical signal derived from a spatial optical signal condensed by the condenser lens in a lens region. The control unit forms a lens region at a desired position of the liquid-crystal lens. The control unit controls an emission direction of the optical signal emitted from the liquid-crystal lens. The light-receiving element is disposed with the light-receiving part facing the liquid-crystal lens. The light-receiving element receives the optical signal focused by the liquid-crystal lens. The decoder decodes a signal based on the optical signal received by the light-receiving element. The light-transmitting unit transmits a spatial optical signal corresponding to the signal decoded by the decoder.

According to the communication device of the present example embodiment, communication using a spatial optical signal becomes possible. For example, if a plurality of communication devices are arranged so that spatial optical signals can be transmitted and received, a communication network using the spatial optical signals can be constructed.

In one aspect of the present example embodiment, the light-transmitting unit includes a light source, a spatial light modulator, a control unit, and a projection optical system. The light source emits parallel light. The spatial light modulator includes a modulator that modulates the phase of the parallel light emitted from the light source. The control unit sets a phase image corresponding to the spatial optical signal in the modulation unit, and controls the light source so that parallel light is emitted toward the modulation unit in which the phase image is set. The projection optical system projects the light modulated by the modulator. Since the communication device of the present aspect includes the phase modulation-type spatial light modulator, it is possible to transmit a spatial optical signal having the same brightness with low power consumption as compared with a communication device including a general light transmission mechanism.

### Eighth Example Embodiment

Next, a light-receiving device according to an eighth example embodiment will be described with reference to the drawings. The light-receiving device of the present example embodiment has a configuration in which the light-receiving functions of the first to seventh example embodiments are simplified. FIG. 23 is a conceptual diagram illustrating an example of a configuration of the light-receiving device 80 of the present example embodiment. The light-receiving device 80 includes a condenser lens 81, a variable lens 83, a light-receiving element 85, and a control unit 87.

The condenser lens 81 condenses the spatial optical signal. In the variable lens 83, the lens region 830 is formed at an arbitrary position. The variable lens 83 focuses the optical signal derived from the spatial optical signal condensed by the condenser lens 81 in the lens region 830. The control unit 87 forms the lens region 830 at a desired position of the variable lens 83. The control unit 87 controls the emission direction of the optical signal emitted from the variable lens 83. The light-receiving element 85 is disposed with the light-receiving part 850 facing the variable lens 83. The light-receiving element 85 receives the optical signal focused by the variable lens 83.

The light-receiving device according to the present example embodiment focuses the optical signal condensed by the condenser lens in a lens region formed in the variable lens, and guides the optical signal to the light-receiving part of the light-receiving element. Therefore, according to the present example embodiment, spatial light arriving from an arbitrary direction can be efficiently received.

(Hardware)

Here, a hardware configuration for executing control and processing by the control unit and the like according to each example embodiment of the present disclosure will be described using the information processing device 90 of FIG. 24 as an example. The information processing device 90 in FIG. 24 is a configuration example for executing control and processing of each example embodiment, and does not limit the scope of the present disclosure.

As illustrated in FIG. 24, the information processing device 90 includes a processor 91, a main storage device 92, an auxiliary storage device 93, an input/output interface 95, and a communication interface 96. In FIG. 24, the interface is abbreviated as an interface (I/F). The processor 91, the main storage device 92, the auxiliary storage device 93, the input/output interface 95, and the communication interface 96 are data-communicably connected to each other via a bus 98. In addition, the processor 91, the main storage device 92, the auxiliary storage device 93, and the input/output interface 95 are connected to a network such as the Internet or an intranet via the communication interface 96.

The processor 91 develops the program stored in the auxiliary storage device 93 or the like in the main storage device 92 and executes the developed program. In each example embodiment, a software program installed in the information processing device 90 may be used. The processor 91 executes control and processing according to each example embodiment.

The main storage device 92 has an area in which a program is developed. The main storage device 92 may be a volatile memory such as a dynamic random access memory (DRAM). In addition, a nonvolatile memory such as a magnetoresistive random access memory (MRAM) may be configured and added as the main storage device 92.

The auxiliary storage device 93 stores various types of data. The auxiliary storage device 93 includes a local disk such as a hard disk or a flash memory. Various types of data may be stored in the main storage device 92, and the auxiliary storage device 93 may be omitted.

The input/output interface 95 is an interface for connecting the information processing device 90 and a peripheral device. The communication interface 96 is an interface for connecting to an external system or device through a network such as the Internet or an intranet based on a standard or a specification. The input/output interface 95 and the communication interface 96 may be shared as an interface connected to an external device.

An input device such as a keyboard, a mouse, or a touch panel may be connected to the information processing device 90 as necessary. These input devices are used to input information and settings. When the touch panel is used as the input device, the display screen of the display device may also serve as the interface of the input device. Data communication between the processor 91 and the input device may be mediated by the input/output interface 95.

The information processing device 90 may be provided with a display device for displaying information. In a case where a display device is provided, the information processing device 90 preferably includes a display control device (not illustrated) for controlling display of the display device. The display device may be connected to the information processing device 90 via the input/output interface 95.

Furthermore, the information processing device 90 may be provided with a drive device. The drive device mediates reading of data and a program from a recording medium, writing of a processing result of the information processing device 90 to the recording medium, and the like between the processor 91 and the recording medium (program recording medium). The drive device may be connected to the information processing device 90 via the input/output interface 95.

The above is an example of a hardware configuration for executing control and processing according to each example embodiment. The hardware configuration of FIG. 24 is an example of a hardware configuration for executing control and processing according to each example embodiment, and does not limit the scope of the present invention. In addition, a program for causing a computer to execute control and processing according to each example embodiment is also included in the scope of the present invention. Further, a program recording medium in which the program according to each example embodiment is recorded is also included in the scope of the present invention. The recording medium can be achieved by, for example, an optical recording medium such as a compact disc (CD) or a digital versatile disc (DVD). Furthermore, the recording medium may be implemented by a semiconductor recording medium such as a universal serial bus (USB) memory or a secure digital (SD) card, a magnetic recording medium such as a flexible disk, or another recording medium. In a case where the program executed by the processor is recorded in the recording medium, the recording medium corresponds to a program recording medium.

The components that execute the control and processing of each example embodiment can be arbitrarily combined. In addition, components that execute control and processing of each example embodiment may be realized by software or may be realized by a circuit.

Although the present invention has been described with reference to the example embodiments, the present invention is not limited to the above example embodiments. Various modifications that can be understood by those of ordinary skill in the art can be made to the configuration and details of the present invention within the scope of the present invention.

This application is based upon and claims the benefit of priority from Japanese patent application No. 2021-047564, filed on Mar. 22, 2021, the disclosure of which is incorporated herein in its entirety by reference.

### REFERENCE SIGNS LIST

10, 20, 30, 40, 80 Light-receiving device
11, 21, 31, 41, 51, 61, 71, 81 Condenser lens
13, 23, 33, 43, 53, 63, 73 Liquid-crystal lens
15, 25, 35, 45, 55, 65, 75, 85 Light-receiving element
17, 27, 37, 47, 57, 67, 77, 87 Control unit
50, 60 Reception device
56, 66, 76 Decoder
70 Communication device
78 Light-transmitting unit
83 Variable lens
410 Reduction optical system
411 First condenser lens
412 Second condenser lens
561, 661 First processing circuit
565, 665 Second processing circuit
662 Control circuit
663 Selector
700 Light-projecting unit
781 Irradiation unit
783 Spatial light modulator
787 Projection optical system
6611 High-pass filter
6613 Amplifier
6615 Integrator
7811 Light source
7812 Collimator lens
7871 Fourier transform lens
7873 Aperture
7875 Projection lens

What is claimed is:

1. A light-receiving device comprising:
a condenser lens that condenses a spatial optical signal;
a variable lens in which a lens region is formed at an arbitrary position, the variable lens focusing an optical signal derived from the spatial optical signal condensed by the condenser lens in the lens region;
a controller including
a memory storing instructions, and
a processor connected to the memory and configured to execute the instructions to
form the lens region at a desired position of the variable lens and control an emission direction of the optical signal emitted from the variable lens; and
a light-receiving element that is disposed with a light-receiving part facing the variable lens and receives the optical signal focused by the variable lens.

2. The light-receiving device according to claim 1, wherein
the variable lens is a transmissive liquid-crystal lens, and
the processor is configured to execute the instructions to form the lens region at a desired position of the liquid-crystal lens by adjusting a voltage applied to the liquid-crystal lens.

3. The light-receiving device according to claim 1, wherein
the variable lens is a reflective liquid-crystal lens, and
the processor is configured to execute the instructions to form the lens region at a desired position of the liquid-crystal lens by adjusting a voltage applied to the liquid-crystal lens.

4. The light-receiving device according to claim 3, wherein
the variable lens is LCOS (Liquid crystal on silicon), and
the processor is configured to execute the instructions to display a virtual lens image that focuses the spatial optical signal toward the light-receiving part of the light-receiving element at a desired position on a display part of the LCOS.

5. The light-receiving device according to claim 1, wherein
the processor is configured to execute the instructions to
scan an emission direction of the optical signal emitted from the variable lens by moving a position of the lens region,
detect an arrival direction of the spatial optical signal based on received light intensity of the optical signal by the light-receiving element, and
form the lens region in the variable lens according to an arrival direction of the detected spatial optical signal.

6. The light-receiving device according to claim 1, wherein
the processor is configured to execute the instructions to
image an arrival direction of the spatial optical signal,
detect an arrival direction of the spatial optical signal based on the image captured by the imaging, and
form the lens region in the variable lens according to an arrival direction of the detected spatial optical signal.

7. The light-receiving device according to claim 1, wherein
the variable lens has a shape corresponding to the arrival direction of the spatial optical signal.

8. The light-receiving device according to claim 1, further comprising a reduction optical system in which a plurality of the condenser lenses are combined.

9. A reception device comprising:
the light-receiving device according to claim 1, and
a decoder that decodes a signal based on the optical signal received by the light-receiving device.

10. A communication device comprising:
the reception device according to claim 9; and
a light transmission device that transmits a spatial optical signal corresponding to the signal decoded by the decoder included in the reception device.
